(19) United States
(12) Patent Application Publication
(10) Pub. No.: US 2014/0075014 A1
(43) Pub. Date: Mar. 13, 2014

(54) PROGRESSIVE ACCOUNT STATES FOR AGGREGATE WEBSITE VISITORS

(71) Applicant: LIMELIGHT NETWORKS, INC., Tempe, AZ (US)

(72) Inventor: DEEPESH CHOUREY, DUBLIN, CA (US)

(73) Assignee: LIMELIGHT NETWORKS, INC., TEMPE, AZ (US)

(21) Appl. No.: 13/646,240

(22) Filed: Oct. 5, 2012

Related U.S. Application Data
(63) Continuation-in-part of application No. 13/614,582, filed on Sep. 13, 2012.

(51) Int. Cl. G06F 15/173

(52) U.S. Cl. 709/224

(57) ABSTRACT

A method of analyzing an Internet-based communication session to use a group profile database and alter group profile states using an aggregated function of individual electronic transmissions may include receiving interactions between a visitor device and the web server as a part of a communication session, detecting that the communication session is associated with a characteristic, determining a group profile in a profile database that is associated with a plurality of communication sessions that are also associated with the characteristic, associating the communication session with the group profile, receiving information from the visitor device, determining that a group profile state associated with the group profile should be changed to a higher group profile state based on the information, receiving a request for gated content from the visitor device, and providing the content based on the higher group profile state.

### CROSS-REFERENCES TO RELATED APPLICATIONS

This application claims the benefit of and is a continuation-in-part of U.S. patent application Ser. No. 13/614,582, filed on Sep. 13, 2012, which is incorporated by reference in its entirety for all purposes.

### BACKGROUND OF THE INVENTION

This disclosure relates in general to customer engagement tools and, but not by way of limitation, to website engagement tools.

Websites are often a part of an integral plan in advertising business solutions and engaging visitors as customers or potential customers. Nurturing those visitors to the website has traditionally taken human expertise, skill, and effort that has been impractical in converting a large number of visitors into customers. While an experienced sales person may be able to quickly evaluate a contact and determine whether or not he/she is a prospective customer, the sheer volume of visitors to a website and the impersonal nature of web interactions make large-scale human involvement infeasible and impractical. Business-to-business websites traditionally have not reached their marketing potential in yielding qualified leads.

Historically, email marketing and sales campaigns have driven visitors to a website to discover information about a company—much like an online brochure. With the advent of sophisticated marketing automation tools, marketing campaigns have focused on creating conversions or registrations to capture visitor data. However, real personalization of the website visitor's experience has not been possible due to the fact that the marketing tools could not instruct a static website what particular content to present to any given visitor. Hence, improvements in the art are needed.

### BRIEF SUMMARY OF THE INVENTION

In one embodiment, a method of analyzing an Internet-based communication session to use a group profile database and alter group profile states using an aggregated function of individual electronic transmissions may be presented. The method may include detecting one or more interactions between a web server and a first visitor device. The web server may provide information associated with a website to the first visitor device, and the one or more interactions may be part of a communication session. The method may also include detecting a characteristic associated with the communication session. The characteristic may also be associated with each of a plurality of communication sessions, and at least one of the plurality of communication sessions may be associated with a second visitor device. The method may additionally include accessing a group profile in a profile database. The group profile may be associated with the plurality of communication sessions, the group profile may be associated with a group profile state in a hierarchy of group profile states, and each of the hierarchy of group profile states may be based on detected interactions associated with the plurality of communication sessions. The method may further include associating the communication session with the group profile, storing the one or more interactions between the web server and the first visitor device in one or more memory locations associated with the group profile, and determining whether the group profile state should be changed after associating the communication session with the group profile.

In another embodiment, a system for analyzing an Internet-based communication session to use a group profile database and alter group profile states using an aggregated function of individual electronic transmissions may be presented. The system may include a web server that stores information associated with a website and provides the information associated with the website to visitor devices. The system may also include one or more ports that receive transmissions between the web server and a plurality of visitor devices. The transmissions may include one or more interactions between the web server and a first visitor device, and the one or more interactions may be part of a communication session. The system may additionally include a profile database that stores a plurality of group profiles. The plurality of group profiles may include a group profile, the group profile may be associated with a plurality of communication sessions where at least one of the plurality of communication sessions may be associated with a second visitor device, the group profile may be associated with a group profile state in a hierarchy of group profile states, and each of the hierarchy of group profile states may be based on detected interactions associated with the plurality of communication sessions. The system may further include one or more processors configured to detect a characteristic associated with the communication session where the characteristic is also associated with each of the plurality of communication sessions, associate the communication session with the group profile, store information associated with the one or more interactions between the web server and the first visitor device in one or more memory locations associated with the group profile, and determine whether the group profile state should be changed after associating the communication session with the group profile.

In yet another embodiment, a method of analyzing an Internet-based communication session to use a group profile database and alter group profile states using an aggregated function of individual electronic transmissions may be presented. The method may include receiving, at a web server, interactions between a visitor device and the web server as a part of a communication session. The method may also include detecting that the communication session is associated with a characteristic, and determining a group profile in a profile database. The group profile may be associated with a plurality of communication sessions, and each of the plurality of communication sessions is associated with the characteristic. The method may additionally include associating the communication session with the group profile, receiving information from the visitor device, and determining that a group profile state associated with the group profile should be changed to a higher group profile state after receiving the information from the visitor device, wherein the group profile state and the higher group profile state can be part of a discrete hierarchy of profile states. The method may further include receiving a request for content from the visitor device, wherein the content is gated, and providing the content based on the higher group profile state.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 illustrates a block diagram of an embodiment of a Web Content Management System.

FIG. 2A illustrates a block diagram of an embodiment of a Lead Management System.

FIG. 3B illustrates a block diagram of another embodiment of a Lead Management System.

FIG. 3A illustrates a simplified flow diagram for authenticating a user using an external data source, according to one embodiment.

FIG. 3B illustrates a second simplified flow diagram for authenticating a user using an external data source, according to one embodiment.

FIG. 4 illustrates an embodiment of a state diagram for a progressive profiling system.

FIG. 5 illustrates an embodiment of a state diagram for transitioning between progressive profile states.

FIG. 6 illustrates an embodiment of a state diagram for transitioning between progressive profile states using an external data source.

FIG. 7 illustrates one embodiment for relating interests to categories of content.

FIG. 8 illustrates one embodiment for relating interests to data from an external data source.

FIG. 9 illustrates a simplified flowchart of a method for linking external data sources to internal profiles, according to one embodiment.

FIG. 10 illustrates an environment with which embodiments may be implemented with a computer system.

FIG. 11 illustrates an embodiment of a special-purpose computer system.

FIG. 12 illustrates a block diagram of a system for maintaining group profiles, according to one embodiment.

FIG. 13 illustrates a block diagram depicting the interactions between a lead management system and a plurality of users, according to one embodiment.

FIG. 14 illustrates a state diagram 1400 for a progression through group profile states, according to one embodiment.

FIG. 15 illustrates a block diagram 1500 of associating interests with group profiles, according to one embodiment.

FIG. 16 illustrates a flowchart 1600 of a method for using group profiles, according to one embodiment.

### DETAILED DESCRIPTION OF THE INVENTION

The ensuing description provides exemplary embodiments only, and is not intended to limit the scope, applicability or configuration of the disclosure. Rather, the ensuing description of the exemplary embodiments will provide those skilled in the art with an enabling description for implementing an exemplary embodiment. It is understood that various changes may be made in the function and arrangement of elements without departing from the spirit and scope as set forth in the claims.

According to some embodiments, a progressive profiling system with discrete profile states can be applied to both individual visitors to a website as well as groups of visitors to a website. In some embodiments, interactions between the website and an individual visitor can be detected and analyzed during a communication session. A characteristic associated with the communication session, such as a business organization, an IP address, or a geographic location, may be detected. This characteristic can then be matched with a group profile. The group profile can be associated with multiple different visitors and/or communication sessions that are all associated with the same characteristic. For example, users associated with the same business can all be associated with the same group profile. The group profile can progress through discrete states in the same way that individual profiles can progress through discrete states. Each individual visitor associated with the group profile can be allowed to access additional content based on the entire group's interactions with the website.

As described below, using group profile information will be described in the context of a website operating in conjunction with a Web Content Management System. Therefore, features of the Web Content Management System, such as interests, categories, profiles, content, templates, and/or the like, will be described in relation to both individual and group profiles.

### Web Content Management System

As used herein, the term “website” refers to a single web domain. The website may be comprised of multiple individual pages; however, each page in the website may be associated with a single business brand or organization. For example, www.clickability.com could be considered a website associated with the Clickability™ brand and product. Each webpage in the www.clickability.com domain could be considered a part of the www.clickability.com website, as used herein.

A Web Content Management System (WCMS) may include computer programs that allow for the publishing, editing, and modifying of data content on a website, as well as maintenance from a centralized platform. A WCMS can typically be used to present information on websites. Data content managed by a WCMS may include items such as documents, movies, pictures, text, scientific data, phone numbers, database information, animations, white papers, product descriptions, navigational structures, contact information, data entry forms, code, JavaScript, interactive chat pages, and/or the like. Serving as a central repository, a WCMS can be used to uniformly raise the version level when new updates are added to an already existing item of data content. The WCMS may be particularly beneficial when used to catalog and index content, select or assemble content at runtime, or deliver content to specific visitors in a requested way. A WCMS may allow client control over files, documents, and other content based on a particular visitor

In some embodiments described herein, the WCMS may be integrated with a lead management system. Generally, lead management is a term used to describe general business practices and methodologies designed to generate new potential business clientele. In other words, lead management facilitates a business's connection between it outgoing customer advertising and the responses to that advertising. Lead manager may include business-to-business strategies, as well as direct-to-consumer strategies. Will the lead management system may be used to manage business inquiries, or leads, in order to guide potential customers through an organization's public information. Embodiments described herein may implement a lead management system in a WCMS. In these embodiments, the lead management system is used to track, guide, and customize a potential customer's interaction with data content of a business organization's website. At a certain level of interaction, the potential customer may be determined to be a lead that is ready for an increased level of sales and marketing exposure and/or contact.

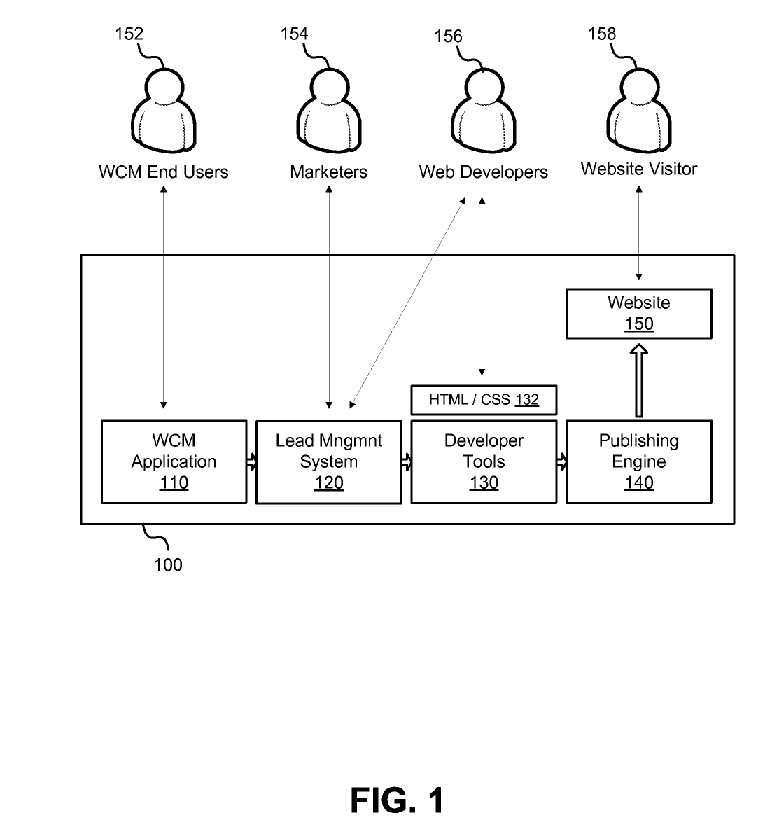

FIG. 1 illustrates a block diagram 190 of a WCMS 100 with an integrated Lead Management System 120. In this embodiment, the WCMS 100 may comprise a software system that provides website authoring, collaboration, and administration tools designed to allow users with varying degrees of knowledge of web programming languages or markup languages to create and manage website content. The WCMS 100 allows tasks related to creating and maintaining a website to be divided between the various parties that are best suited to completing those tasks. It also allows marketers to control aspects of how content is presented and how the website is organized. An example of a WCMS 100 is available from Clickability™

The Web Content Management (WCM) application 110 can comprise an application used to create and manage all content media, functionality, page designs, and page layouts that are used to build and maintain a website 150. WCM end users 152 may be primarily editors, authors, designers, and developers. A set of developer tools 130 may be comprised of the various development languages, tools and environments needed to create the design, structure, logic, and presentation of the website 150. In one embodiment, a template language designed by Clickability™ may be used in conjunction with the Apache™ Velocity Engine to implement the developer tools 130. Web developers 156 typically use the developer tools 130 and the functionality defined by the Lead Management System 120 in the WCMS 100. A publishing engine 140 may dynamically combine the content managed in the WCM application 110 with the templates and HTML/CSS designs from the developer tools 130 to create and render the pages of the website 150. A visitor 158 to the website 150 may interact with the website 150, and the experience of the visitor 158 may be monitored and customized by the lead management system 120. As used herein, the terms “visitor” and “user” may be used interchangeably to refer to a visitor to the website whose interactions are tracked and/or scored to determine whether they should become a qualified lead. Similarly, the terms “visitor device” and “user device” may also be used interchangeably to refer to a digital computing device used by the user/visitor during such interactions with the website.

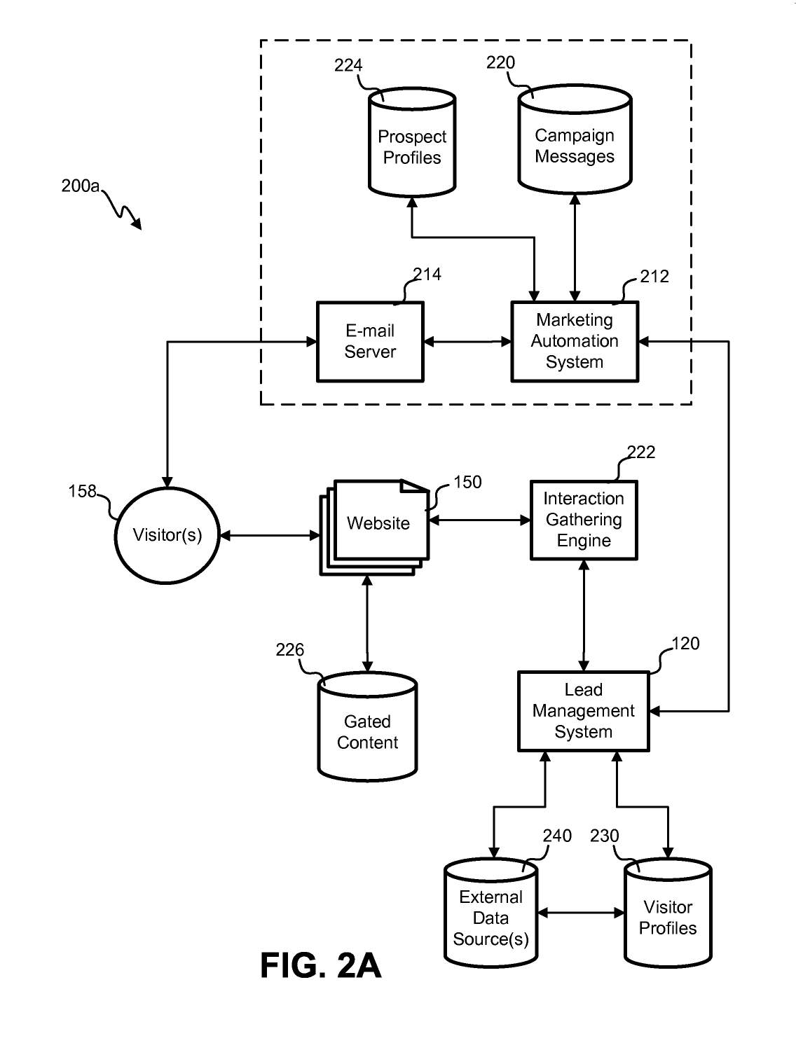

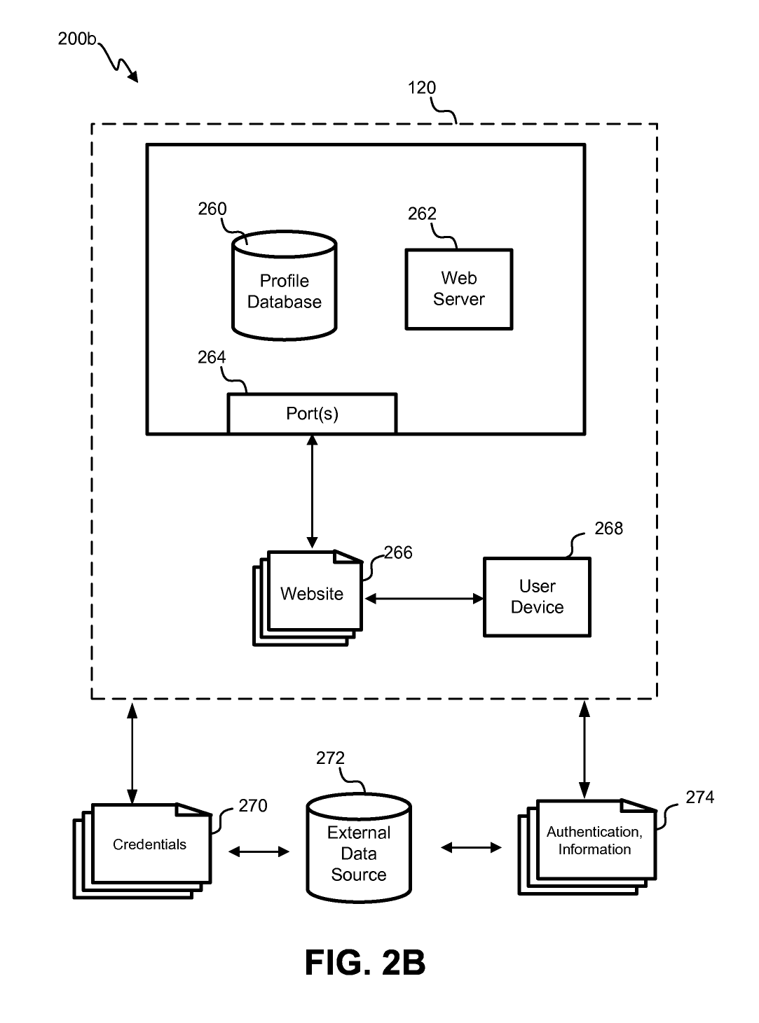

Turning next to FIG. 2A, a block diagram 200a of an embodiment of a lead management system 120 and some of the many possible surrounding systems is shown. Visitors 158 interact with a website 150 monitored by the lead management system 120. A marketing automation system 212 may drive prospects to the website 150. Although a marketing automation system 212 is shown separately, the marketing automation system 212 could be integrated with the lead management system 120 in other embodiments. The lead management system 120 choreographs the website's interactions with the visitor 158 to lead to a sale or deepen the relationship with the visitor 158.

The marketing automation system 212 in this embodiment may perform e-mail campaigns on prospective customers to engage such individuals at the website 150. Campaign messages 220 are distributed through the e-mail server 214 to prospective customers that may click-through the e-mail message to a landing pad on the website 150. The campaign messages 220 can be customized for a particular prospect. Where a prospect becomes a visitor 158 at the website 150, the prospect profiles 224 can optionally be provided to the interaction gathering engine 222 in some embodiments.

The lead management system 120 may include the interaction gathering engine 220 that monitors the behavior a visitor 158 on the website 150 and records information about the visitor 158. The interaction gathering engine 222 could be hosted on the same computer system, hosting service or content delivery network (CDN) as the website 150. Some information may be provided by external sources, such as the marketing automation system 212. The website 150 provides some information to all visitors 158, but other gated content 226 may be provided to visitors 158 who have reached a particular qualified level.

Information for the visitors 158 and their behavior on the website 150 are monitored by the interaction gathering engine 222. The lead management system 120 takes the information and stores it in user profiles 230. Interaction between the lead management system 120 and the marketing automation system 212 allows sharing of profiles 224, 230. Additionally, the lead management system 120 can trigger the marketing automation system 212 to perform an e-mail campaign, along with other systems (not shown) that can be used to further contact visitors 158.

The lead management system 120 can access and store information in a variety of different databases. In one embodiment, a visitor profiles database 230 may be used to store local profile information used in conjunction with a lead score to elevate visitors through a hierarchy of profile states. Additionally, external data sources 240 may be accessed to retrieve additional information about a visitor. In one embodiment, external data source 240 may provide login authentication services and return a value that can be matched with an existing visitor profile in the visitor profiles database 230. In some embodiments, the external data sources 240 can also provide additional personal information that can be stored in a profile in the visitor profiles database 230.

Turning next to FIG. 2B, a block diagram 200b of another embodiment of a lead management system 120 and some of the many possible surrounding systems is shown. In this embodiment, the lead management system 120 may include a profile database 260 a Web server 262, and one or more ports 264 (or interfaces). The profile database 260 can be configured to store a plurality of user profiles, where each of the plurality of user profiles can be associated with at least one of a hierarchy of profile states. The hierarchy of profile states and how a visitor can move between these states is discussed further herein below. The Web server 262 can be configured to facilitate interactions between the Web server 262 and a user device 268. The Web server can provide information associated with a website 266 to the user device 268.

The interactions between the Web server 262 and the user device 268 can include a request for login credentials of the user. In one embodiment, the Web server 262 may provide a login page or set of fields as a part of the website 266 that is presented to the user on a display device of the user device 268. The user may enter user credentials, such as a username and/or password, using the user device 268 that are then sent to the website for verification 266. In another embodiment, the website 266 or the Web server 262 could redirect a browser operating on the user device 268 to an external data source 272. As part of the redirect, the user credentials 270 could be sent to the external data source 272 for authentication. In response, the external data source 272 can return an authentication of the user's identity, along with (optionally) information associated with a user or user account. The authentication and/or information can be returned to the user device 268 and forwarded to the website 266, or alternatively, could be returned directly to the website 266. In another embodiment, the website can directly send the credentials 270 to the external data source 272, and may directly receive the authentication and/or information 274 from the external data source 272. It will be understood that other configurations for sending and receiving credentials and authentication information may be used by various embodiments. The examples discussed herein are not meant to be limiting, but are shown to provide an enabling disclosure.

In one embodiment, the external data source 272 may be geographically away from the Web server 262. The external data source 272 may also be referred to as being remote from the Web server 262. In one embodiment this may comprise the Web server 262 and the external data source 272 being separated by distance of greater than 1 mile. In another embodiment this may comprise the Web server 262 and the external data source 272 being separated by distance of greater than 10 miles. In yet another embodiment this may comprise the Web server 262 and the external data source 272 being located in separate facilities and/or powered by separate power sources.

It will also be understood that arrangement of the WCMS 100 and the lead management system as depicted in FIG. 1 and FIG. 2 is merely illustrative. Many other arrangements of software and hardware functionality are possible. For example, software modules that are depicted as separate in these figures may be combined into the same software module. Likewise, software modules may be divided an implemented remotely from one another in different hardware systems. Additionally, the various roles assigned to web developers, marketers, users, and content designers may be reassigned according the individual needs and expertise of an implementing business.

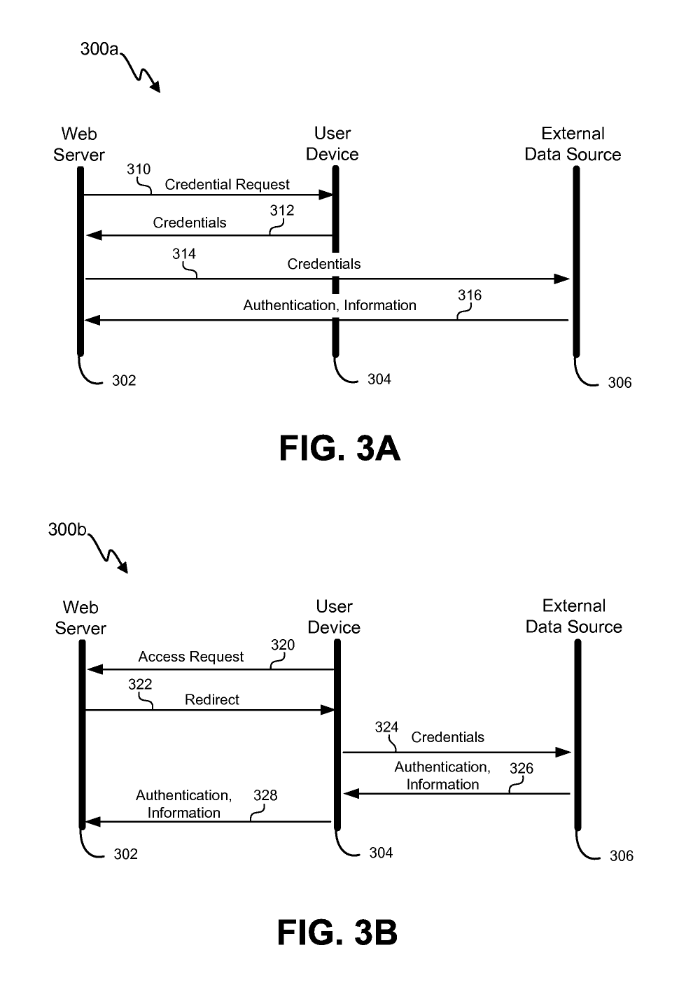

FIG. 3A illustrates a simplified flow diagram 300a for authenticating a user using an external data source, according to one embodiment. This embodiment may be used in instances where a user provides credentials to a website hosted by a Web server 302 that is associated with the WCMS. For example, a website could provide a login page or a set of fields using a service such as Facebook®, Disqus®, Google®, Twitter®, Yahoo®, OpenID®, etc., which provide login services. In this embodiment, the Web server may present a credential request in the form of a pop-up, webpage, web form, and/or the like, to be displayed on the user device 304 (310). In response, the user may provide credentials by entering them into the user device 304 and sending the credentials to the Web server 302 (312). As used herein, the term “credentials” may be used to describe any single datum or combination of data used to authenticate the identity of an individual, system, or process. Depending on the particular embodiment, a credential may comprise a username, a password, a PIN, a passcode, a voice identification, a digitized fingerprint, a photograph, a retinal scan, a biometric identifier, a hardware key, a public or private encryption key, a system configuration, a hardware profile, a device ID, a user ID, a Social Security number, and/or the like.

After receiving credentials, the Web server 302 may send the credentials to an external data source 306 for verification (314). For example, the Web server 302 could send the credentials to the service such as Facebook® to verify the credentials. The external data source 306 may send a message to the Web server 302 that indicates that the credentials have been authenticated (316). As used herein, this message may be referred to as an “authentication.” An authentication need not include any special cryptographic verifier, but can be as simple as returning a user ID or other information that can be linked to the user such that the Web server 302 can determine that the external data source 306 recognized the credentials as associated with a valid user. Additionally, the external data source 306 can send information associated with the user or the user account to the Web server 302. For example, a service such as Facebook® may return information such as an e-mail address, a user ID, a photograph, a first name and/or a last name. The exact type of information returned by the external data source 306 may depend on the particular implementation. Note that the external data source 306 is not limited to Facebook®. Instead, Facebook® is simply one example of an external data source 306 they can be used in this embodiment. Other types of information that may be provided by the external data source 306 may include, but are not limited to, interests, blog posts, forum posts, photographs, friends, job history, employer, media, music, videos, political affiliations, and/or the like, or metadata/descriptions of any such information.

In an alternate embodiment (not shown), the Web server 302 may determine whether a user or user device 304 is already logged in using the external data source 306. In one embodiment, the request for login credentials (310) may include the Web server 302 determining whether the user device 304 is already logged in to a service, such as Google®, that maintains identity login information. The user device 304 may respond with a simple indication that the device and/or user is logged in to the service hosted by the external data source 306 by identifying a cookie, or other type of identifier stored by a web browser. The user device 304 may also store additional indicators of a login, depending upon the embodiment.

FIG. 3B illustrates a simplified flow diagram 300b for authenticating a user using an external data source, according to one embodiment. This embodiment may be used in instances using a Single-Sign On (SSO) solution, a Federated Identity Management system, or other similar services. Note that these embodiments may also follow the communication flow similar to that shown in FIG. 3A. In embodiments that follow a communication flow similar to that of FIG. 3B, a Web server 302 may receive an access request from a user device 304 (320). In response, the Web server 302 may redirect the user device 304 to an external data source (322). The user device 304 may then provide credentials to the external data source 306 to authenticate the identity of the user (324). The external data source 306 may send an authentication and/or information related to the user and/or user device 304 to the user device 304 (326). The user device 304 may then forward the authentication and/or information to the Web server 302 (328). Alternatively, the external data source 306 may directly send the authentication and/or information to the Web server 302.

In one embodiment, transactions similar to those shown in FIG. 3A and FIG. 3B may take place during separate web sessions. In other words, a visitor can provide credentials and receive an identifier from the external data source during a first web session. During the first web session, the identifier may be associated with a new or existing internal profile. During a subsequent, or second, web session the identifier may again be obtained from the user device or from the external data source, and the existing internal profile may be located using the identifier. Interactions between the user device and the Web server can be stored in the same user profile during both the first web session and the second web session. In one embodiment, the first web session and the second web session are separated in time by at least one day. In other embodiments, the two sessions may be separated by an hour, five minutes, one week, and/or the like.

### Tracking Visitors and Establishing User Profiles

In order to assess the interactions of a visitor with a website, ascertain interests, and create a qualified lead, the website may need to identify individual visitors, then track and store information such that the visitor's overall quality as a lead can be assessed. When a visitor first accesses the website, the visitor may be classified as an anonymous visitor. The interactions with the website by an anonymous visitor may be a singular visit, or they may be comprised of multiple visits, where each visit may have one or multiple page requests within the website. The end of a visit may be governed by a period of inactivity, and a visit may be deemed complete after the period of inactivity surpasses an established visit-timeout value. For example, a period of inactivity of 30 minutes may signal the end of a visit. In some embodiments, if a visitor closes their browser and returns within the timeout period, the visitor may be credited with a new visit rather than a continuation of the previous visit. Some embodiments may also use an aging cutoff to detect stale visitors. For example, if the time between visits to the website exceeds the aging cutoff, such as 120 days, and the visitor has not submitted information for a user profile, then the website may start a new user profile for the visitor. Alternatively, if the visitor has established a user profile, then an expired account may reset certain information in the user profile that is likely to be stale at that point.

To track a visitor, a lead management system in a WCMS may have logic added to at least some of the published pages within the website specifically for this purpose. For example, the website could check for a “vmSessionId” cookie, which may include a string token that may uniquely identify each visitor. If such a cookie exists, the website may load any information that has been saved by the website for that particular visitor. If the vmSessionId cookie does not exist, the website may create a new anonymous visitor profile and create a vmSessionId cookie in the browser of the visitor. Additionally, if the visitor does not have a vmSessionId cookie, the website may present the visitor with the opportunity to provide identifying information, such as a user name and/or password, to identify the visitor for this web session and for future web sessions. In this case, the website may recreate a vmSessionId cookie and load information about the visitor from a stored user profile. This may allow the website to recognize the visitor on a subsequent visit without the visitor being required to provide any identifying information.

After an anonymous user profile is established for the visitor, any information provided by the visitor and any information that may be ascertained by analyzing the interactions of the visitor with the website may be stored in the user profile. As more information is collected from a visitor, the anonymous user profile may be populated such that the visitor is no longer considered anonymous, but instead becomes an engaged prospective sales lead. Any and all aspects of the website interaction may be stored in the user profile, such as the interests, contact information, and/or business needs of the visitor. The various uses and function of the user profile are discussed in greater detail later in this disclosure.

While much of the information stored in a user profile may be provided by the visitor or ascertained by analyzing the visitor's website interactions, it is also possible to import information about a visitor based on an IP address. In one embodiment, the website may be able to detect the IP address of the visitor, and then an existing database may be queried using the IP address to gather additional information about the visitor. For example, Demandbase® is a third party service that can provide information about a business based on an IP address. Another such product is Geo Location from MaxMind®, which provides geographic location information based on the IP address of the visitor. The information acquired from an IP mapping service may be imported into the user profile of the visitor. In the case where visitor is new or anonymous and the user profile is empty, the information from the IP mapping may be used to initially populate a user profile with information. Using services such as these also relieves the visitor of the need to provide this information themselves, which may in turn ease the process of creating a qualified sales lead, and alleviate visitor frustration associated with filling out web forms.

In addition to individual user profiles, accounts may also be established for businesses. A business account may be established explicitly by the business by registering as such with the website. Alternatively, if a visitor provides information identifying the business of the visitor, a separate business account may be created. In some embodiments, IP mapping as described above may be used to identify a business and to identify individual visitors associated with that business. For example, a new visitor may access the website, and the website may recognize the IP address of the visitor as belonging to, for example, Limelight Networks. In this case, a business account for Limelight Networks may be created and populated with information about the business through methods similar to those described above. Additionally, a user profile could be created for the visitor, and the user profile could be linked to the business account, and/or information from the business account could be imported and stored in the user profile. Business accounts may be useful for a website to ascertain, depending upon the particular embodiment.

In addition to IP mapping, the external data sources described above for user logins may also provide profile information to be stored locally on the Web server. When first accessing a website associated with a WCMS, a user may be prompted to create an account or login to an existing account. If a user already has an existing account with the website, the user can provide login credentials that were previously agreed upon between the user device and the website. However, a number of available login options may also be made available to a user. As discussed above, these may include options such as Facebook®, Disqus®, Google®, Twitter®, Yahoo®, OpenID®, and/or the like. In some embodiments, the services may be presented to a user for their convenience. In various embodiments, using these services may be more appealing to a user, may decrease the number of usernames and passwords the user is required to remember, make the user feel more secure using the website, and/or may overall encourage the user to provide login information.

In one embodiment, a user may provide credentials to the external data source or to the website for authentication as described in relation to FIG. 3A and FIG. 3B. The external data source may return information to the website that can be used identify the user. This information can be used to uniquely identify the user and can be linked to a local profile. For example, an external data source may return an e-mail address for the user. The website could then use the e-mail address to create a local profile. Additionally, the e-mail address may be matched to an e-mail address previously stored in a local profile that was created by the user during a prior web session. As will be described below, the local profile may store any and all interactions that a user has with the website. During subsequent web sessions, the user may again login using the external website, which will again provide the user's e-mail address. Each subsequent visit can link the e-mail address to the existing user account. Thus a local profile can be stored for a user that is identified using an external data source in such a way that the user need not be aware that a local profile is created. Another embodiment may also allow information to be segregated between internal profiles and external data sources. For example, an identity management system for personal medical records may be used to provide login information. The external data source could provide identifying information to be used to track a user's interactions with a website, while simultaneously protecting confidential medical information.

The information returned from the external data source and used to link the user with a local profile can vary depending on the implementation. In one embodiment, the external data source may return an external user ID, such as a Facebook® ID, which can be stored locally and used to link the user with a local profile. In other embodiments, the external data source may return an e-mail address, a first name, last name, a Social Security number, a driver's license number, a screen name, and/or any other identifier that may be considered approximately unique to the user. The website may examine the information that is returned from the external data source and select one portion of the information to be used as an identifier to link the user to a local profile.

In some embodiments, a different type of information may need to be used for each external data source. For example, one external data source may return an e-mail address, while another external data source may return a user ID number. The system may allow for users to log in using more than one external data source. For example, during one web session a user may log in using Facebook®, while during another web session a user may log in using Twitter®. In this case, the local profile could store a unique user ID number from each data source to accommodate both logins. In other cases, multiple external data sources may use a common identifier, such as an e-mail address. Generally, the local profile may store an identifier for each external data source along with a field that can be used to link the external data source login to the internal profile.

In some cases, the website and the external data source may operate according to an agreement in order to standardize some of the information that is provided by the external data source after a login. This may be particularly useful in embodiments where the external data source may not normally return information that can be used to uniquely identify a user and/or user device. In this embodiment, the external data source can be instructed to provide or create an external user ID to be provided to the website during a login authentication. The external user ID may be specially created according to the agreement, and may be used in some cases to exclusively link the external data source to the internal profile.

For user convenience, the website may provide multiple login options to the user. For example, a user may be presented with fields to provide local login information, as well as options to use external data sources for login. In one embodiment, users may also be given the option to link an internal profile to an external data source. For example, a user may have an internal profile associated with a username and or password. After logging in locally, the user may also provide credentials to an external data source. Alternatively, the user may instruct the website to provide previously-provided credentials to the external data source. When the external data source returns an authentication and/or information, some of the information may be used to link the external login to the internal profile. Similarly, users with internal profiles may be allowed to sever links to external data source logins.

In some cases, a visitor may be considered anonymous, as described above. The website may be able to determine whether the user and/or user device is currently logged into a known external data source. For example, a cookie stored locally on a user device may be queried to determine that a user is logged into Facebook®. In this case, the website may query the external data source for personal information associated with the account. Then, an internal profile may be created and automatically linked with the external data source account, and the anonymous visitor's interactions with the website may be tracked in the newly-created local profile. On a subsequent visit, the visitor may be identified using a cookie indicating that he/she is currently logged into the same external data source. Also, the visitor may choose to provide a login or create an explicit local account during a subsequent visit, at which point the internal profile may be linked with the credentials provided by the visitor at that time.

When creating or augmenting a user profile using external data source, some external data source interfaces may allow a website to request varying amounts of information from the external data source. The external data source may use preferences, possibly stored by the user, to determine whether such request should be granted. In one embodiment, the website may request all publicly available information linked to the user's external data source account. In another embodiment, the website may request information that is related to the content of the website, such as professional associations, employers, e-mail addresses, home addresses, and/or the like. This request may be made at the same time as an authentication request is made using the credentials provided by the user. Alternatively or additionally, this request may be periodically repeated to determine whether new information has been made available by the user of the external data source.

### Lead Scoring

Lead scoring is a method for a marketer to quantitatively assess a sales prospect's interest in the marketer's products. The marketer may define parameters for creating, incrementing, and decrementing lead scores based on various factors. Explicit factors may be used, such as demographic information, expressions of the interests of a visitor in the marketer's products, company size, industry segment, job title, and/or geographic location. Implicit factors may be derived by monitoring a sales prospect's behavior. Examples of implicit factors may include website visits, e-mail openings, clicks on advertisements, and/or accessing information. Any of these explicit or implicit factors may be tracked by the marketer and may contribute, either positively or negatively, to a lead score. Generally, a higher lead score may indicate that the prospect is likely to respond favorably to further interaction with the marketer's attempts to solicit a sale, and that eventually the prospective customer should be routed from the marketing department to the sales department.

In the context of a website operated by a WCMS, the concept of lead scoring may be tailored to track the actions of a visitor to the website. Explicit factors contributing to lead score of the visitor may include filling out online forms, requesting information, participating in chats, and/or registering a user profile or account with the website. Implicit scores may be derived from monitoring various forms of the online behavior of the visitor, such as number, frequency, and recency of website visits, whitepaper downloads, website navigation, access of specific content, and/or searching for products or solutions. Each of these factors may have a numerical score associated with the factor, and that score may be added to, or subtracted from, the overall lead score of the visitor. Scoring may be dynamic, such that the score associated with a current action may be increased or decreased based on previous actions. For example, each visit to a webpage that is related to the same topic may increase the score associated with each successive viewing of each new webpage. On the other hand, multiple views of the same webpage may decrease the score associated with each successive viewing of the same webpage, depending upon the particular embodiment.

As the lead score for a particular visitor increases during their association with the website, the WCMS may take actions to increase the website's interactivity with the visitor. Generally, certain threshold values may be established to act as triggers. As the lead score of the visitor crosses a threshold value, the website may present the visitor with more interactive content that may be calculated to increase the assumed interests of the visitor in the offerings of the website, or to solicit additional information from the visitor. The lead score of the visitor may cross the threshold value in both the positive and negative direction. Crossing a threshold in the positive direction may indicate that the visitor is expressing increased interest in the website, while crossing a threshold in the negative direction may indicate that the visitor is losing interest in the website. In either case, the website may need to show content that is more targeted towards the interests of the visitor, or the website may need to show content that is more varied in order to find something that the visitor is more interested in viewing. In some embodiments, a threshold score may be determined, which when crossed, may designate the visitor as a qualified lead, i.e., a lead that is ready for more aggressive and/or direct contact with a sales department associated with the website. When the lead score of the visitor indicates a qualified lead, the WCMS may be programmed to alert the sales department, to present purchasing opportunities to the visitor, or to take any other action that may be calculated to follow up the expressed interest of the visitor with a sales opportunity.

Lead scoring may take various forms, and may depend on a number of different factors associated with the website. In some embodiments, a score may be associated with each detectable action taken by a visitor while interacting with the website. For example, a value of “25” may be added to the lead score of a visitor every time the visitor downloads a document from the website. In this case, the action of downloading the document could be statically programmed into the WCMS such that every instance of downloading the document may increase the lead score of the visitor by 25 points. On the other hand, it may also be beneficial to dynamically determine the appropriate score at the time of the action based on the history of actions by the visitor and how those actions correlate with the interests of the visitor. For example, the website may be added to the lead score of the visitor when the visitor downloads three or more documents, in addition to tracking and scoring each of the individual downloads.

In one embodiment, visitor interactions with the website can generally be placed in three categories for scoring: (1) content and media items, (2) actions, and (3) information submissions. Content and media items may include viewing videos, product specifications, sample code, and/or training materials, downloading trial software, white papers, audio or video presentations, or using online resources, such as web forms, online calculators, spreadsheets and/or the like. The action category may include searches, number of visits, frequency of visits, navigation between pages, accessing content through specific web portals, adding items to a resource portfolio, creating a user profile, saving research trials and/or searches in a user profile, and/or the like. Information submissions may include all instances where the visitor provides personal or business information to the website, for example, filling out a web form, saving information in a user profile, revealing an association with a business, and/or expressing interest in business solutions associated with the website. These categories are illustrative, and not meant to be limiting. It will be understood that these categories may be changed to meet needs and content of each individual organization and website.

In some embodiments, information submissions may be explicitly linked to voluntary submissions by a user. These may indicate a level of user interest. In other embodiments, information submissions may also include information provided by an external data source, such as external data sources used to log in a user as described above. In some cases, the information requested from a user by the website and the information provided by an external data source login may be very similar. For example, a first request for information by the website may focus on personal information used to identify a visitor. Similarly, an external data source may provide personal information, including names, addresses, e-mails, phone numbers, businesses, and/or the like. When the information overlap sufficiently, the information provided by an external data source may be treated similarly to information provided explicitly by a visitor.

When a WCMS is used to present a website's content, the score for each type of interaction may be determined within the WCMS. In one embodiment, a section of the WCMS interface may be set aside for setting the threshold lead scores and the corresponding actions that may be taken in response to the crossing threshold scores. For example, it may be possible in the WCMS to specify a threshold for a “qualified lead” score. Such a threshold may be set universally and applied to each visitor, or the threshold may be set differently for different classes of visitors. For instance, the threshold may be set to “100” for visitors who are unassociated with a business account, while the threshold may be set to “75” for visitors who are associated with a business account. Alternatively or additionally, a threshold may be set higher/lower for a visitor having information provided by an external data source, such as an external logins, and so forth.

In addition to setting the threshold levels, a WCMS may include an interface for setting the scoring values for each instance of visitor interaction with the website. For example, a WCMS may include a means for selecting specific content, media, and/or actions, and may assign a lead score value to each type. In one embodiment, a lead score value is set for each content instance of a certain type. For example, when a visitor watches any demonstration video, a score of “10” may be added to the visitor's lead score. Content may be scored collectively based on content type (video, audio, and/or documents, etc.), by content category (products, research, and/or marketing, etc.), or by interest of the visitor (solutions for managers, data sheets for engineers, sales solutions, etc.). If no score is set for a particular type of interaction, the WCMS may set a default scoring level to apply to each unassigned interaction.

Additionally or alternatively, each instance of a website interaction may be scored individually, as described above. One embodiment may allow for assigning specific scores to each instance, such that downloading a first white paper would have a score of “10”, while downloading a second white paper could have a score of “15”. Assigning values to specific content may be done by a website developer and available to the WCMS through exposed tags in the content code that may be accessible to the WCMS, or the scores may be entered into the WCMS by marketers when the content is published to the website, depending on the particular embodiment.

According to one embodiment, lead scores may also be associated with each instance where a visitor provides information to the website. During the course of navigating the website, various types of information that may be requested from a visitor, such as e-mail, job function, size of company, and/or the like. In one embodiment, filling out a web form may be associated with a predetermined lead score. Optionally, each field within the web form may be individually associated with a lead score that can be added to the visitor's lead score when it is properly populated with data from the visitor. In one embodiment, an interface within the WCMS may be provided by which particular lead scores can be associated with each web field. For example, if a visitor fills out a web form and provides an e-mail address, then the associated lead score of “10” could be added to the lead score of the visitor.

Lead scores may also be associated with information provided by external data sources used during a login procedure. In one embodiment, information provided by the external data source may be scored in a manner similar to situations where the same information would be entered explicitly by the user in a web form. In another embodiment, a lead scored may be associated with each different external data source selected by a user. For example, a user may select two different external data sources, each providing different information to the website. A lead score of 10, for example, may be associated with each external data source identified and linked by a user. Furthermore, when a user links an external data source to an existing internal profile, additional points may be added to a lead score. Linking an account in this manner may indicate that the user is willing to share information stored by the external data source.

When determining the lead score values to associate with each type of visitor interaction, it may be advantageous in some embodiments, depending on the particular implementation, to develop a scoring strategy to avoid overlapping lead score contributions and accurately gauge visitor interest. For example, some embodiments can divide lead score points between viewing a page with a download link, clicking on the link, and watching media associated with the link. Additionally, there may be a variety of ways to establish, track, and divide lead scores for the website's content and actions. It will be understood that the lead scoring methods described above are merely illustrative.

### Progressive Profiles

When a visitor is associated with a user profile, the website may be programmed to collect personal, business and other information from the visitor. In a way to similar to how a lead score may indicate the value of a visitor based on their activity on the website, a user profile may be incrementally filled with information and indicate a the willingness of the visitor to receive further sales interactions. A progressive profile may be defined as a user profile designed to have a number of different levels, or states, corresponding to increasing amounts of information provided by the visitor. Progressive profiling may enable marketers to capture an increasing amount of information about individual visitors over time, incrementally enriching the user profile. Generally, a visitor will gradually complete their profile; however, it is also possible for a visitor to supply a large amount of information in a single session and jump between multiple profile levels or states.

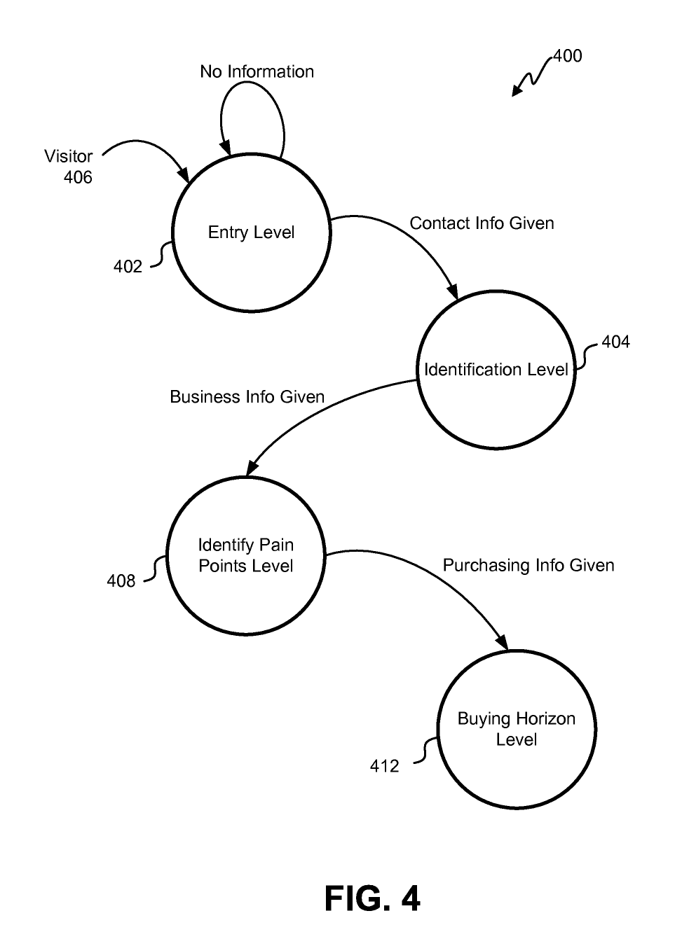

In one embodiment, the each profile level can be associated with a certain type or number of information fields that must be completed by the visitor before the profile is allowed to progress to the next level. In another embodiment, each profile level can be associated with a particular piece of information that needs to be received from a visitor in order to progress to a subsequent level or state. FIG. 4 illustrates a state diagram 400 of an embodiment of a progressive profiling scheme. The progression between the various levels in the progressive profiling scheme may depend, at least in part, on the amount of information provided by a visitor 406. When a visitor first encounters the website, the visitor 406 may be associated with an anonymous, or entry level profile. The entry level profile may be assigned to new visitors, anonymous visitors, or to visitors for whom there is very little known information. At a certain point, the visitor 406 may be asked, for example, for identifying contact information. If the visitor 406 provides the identifying contact information, the profile can progress to the next level, which may be termed the “Identification Level” 404. Similarly, if the visitor 406 continues to navigate through the website and/or access content, the website may be programmed to present the visitor 406 with the opportunity to provide a second level of information.

According to one embodiment, the second level of information may relate to business needs. If the visitor 406 provides the business needs information, the profile may progress to the next level, which may be an “Identify Pain Points” level 408. In one embodiment, this level may be reached when the visitor 406 provides information about specific products and/or services they are interested in. These specific products and/or services may relate to a specific needs of the visitor 406, which may be termed “pain points”. Finally, at some point the visitor 406 may be given the opportunity to provide the website with purchasing information. If such information is provided, the profile may progress to a final level termed the “Buying Horizon” level 412.

The example shown in FIG. 4 is merely illustrative, and is not meant to be limiting. It will be understood that many different profile progressions may be used, and that the information required from each level may be tailored to meet the unique needs of a business. For example, a company may require extensive contact information, including first name, last name, username, e-mail, address, city, state, zip, country, company, phone number, fax number, mobile number, website, birth date, ideal contact times, and/or the like. For business information, a website may be programmed to require a business name, industry, size of company, listings of various business interests, revenues, and/or problems that the visitor 406 is attempting to solve. For purchasing information, the website may be programmed to require a budget, purchasing timeframe, role in the purchasing process, purchasing contact, and/or a listing of more specific business interests. These types and categories of information may be enlarged or reduced, and may be subdivided according to the marketing plan of the website owner/operator. In one embodiment, the desired profile fields may first be chosen, and then they may be grouped by type and divided into various progressive profile levels that are arranged according to perceived willingness of the visitor 406 to divulge the information.

Some embodiments present the same profile questions to every visitor associated with a given profile level. However, some embodiments may allow the progressive profile questions to be tailored to the type of visitor, such that different visitors may receive different questions at the same level based on information that has already been provided. Certain questions may pertain to, or change depending upon, answers to previous questions. For example, during a request for information, a visitor may be presented with the question “How large is your business?” If the visitor responds with a business size that is larger than a threshold number, then the next question may ask about topics that would only apply to a large business. On the other hand, if the visitor's response indicated that the business is comparatively small, then the next question may ask about topics that would only apply to a small business. It will be understood that many variations are possible when segmenting the profile questions into different categories. Some embodiments allow the website to use complex rules for segmenting the order, number, and topics for each profile questionnaire. For example, it is possible to have an interface in the WCMS where rules and alternatives for each question may be selected and tailored to the individual visitor type.

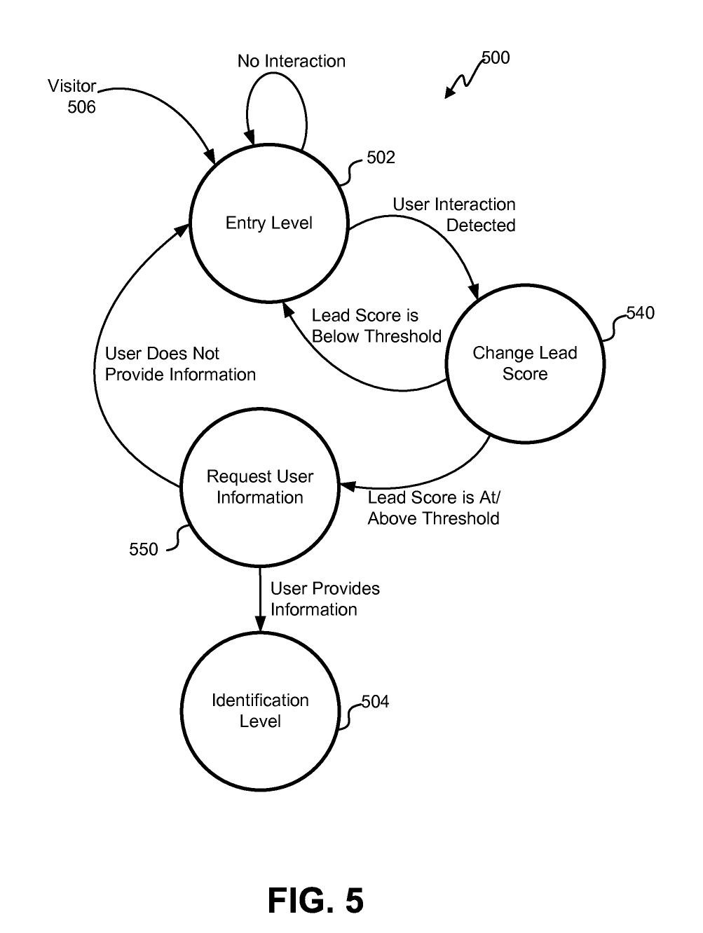

In some embodiments, the profile levels/information and a lead score of a visitor may both be stored in the user profile of the visitor, yet these two measurements of lead progress may be independent of each other to varying degrees. However, in one embodiment, the lead score may be used to trigger the requests for visitor information required to progress through the profile levels. FIG. 5 illustrates a state diagram 500 of an embodiment of a progressive profile system that uses the lead score of a visitor to trigger requests for visitor information and profile level advancement. When a visitor 506 first encounters the website, the visitor 506 may be associated with an entry level profile state 502. As the visitor 506 interacts with the website, the lead score of the visitor 506 may increase and decrease based on the types of interactions while associated with the entry level profile state 502.

In one embodiment, every time an interaction by the visitor 506 is detected, the lead score of the visitor 506 can be adjusted in state 540. Each time the lead score of the visitor 506 is adjusted, the lead score can be compared to a threshold value. So long as the lead score of the visitor 506 stays below the threshold, no action needs to be taken, and the visitor 506 will persist in the entry level profile state 502. If at some point the lead score of the visitor 506 meets or exceeds the threshold, the website may present the visitor 506 with the opportunity to provide contact information to the website in state 550. If the visitor 506 provides the requested information, the profile level of the visitor 506 may increase to the “Identification” level 504. On the other hand, if the visitor 506 fails to provide the requested information, the profile level of the visitor 506 may revert back to the “Entry” level 502. If the user profile level reverts back to the “Entry” level 502, then the visitor 506 may be presented with a similar information request each subsequent time that a visitor 506 interaction is detected and the score increases above the threshold value. Alternatively, the lead score of the visitor 506 may be reset or reduced to the threshold of the current level, or the threshold value of the next level may be increased to allow for more navigation before the next information request is made.

Other factors may be used in addition to using the lead score of the visitor 506 as a mechanism to trigger presenting the visitor 506 with an information request. In some embodiments, a specific type of interaction by the visitor 506, such as accessing a specific section of content may trigger an information request, even if the lead score of the visitor 506 has not yet reached the threshold value. In this case, content may be “gated” such that only visitors who have achieved a certain profile level may be allowed to access the gated content. For example, in order to access a demonstration video of a product solution on the website, the visitor 506 may be required to provide enough information to have progressed past the first profile level. If the visitor 506 has already provided enough information to move to the second profile level, then the visitor 506 may be able to access the content. If instead the visitor 506 has not yet provided enough information to move beyond the first profile level, then the visitor 506 may be diverted from the demonstration video and given an opportunity to provide the requested information. If the information is provided at this time by the visitor 506, the visitor 506 may be given access to the demonstration video. On the other hand, if the visitor 506 does not provide all of the requested information, the website may deny access to the demonstration video, or it may grant some form of limited access, such as a one-time viewing of the demonstration video. Using gated content in this manner may entice the visitor 506 to provide information to the website that the visitor 506 might otherwise be reluctant to divulge.

When using gated content as described above, it may be necessary for the visitor to ascend through two or more profile levels during the same interaction. For example, if the visitor attempts to access content that has been gated at a certain profile level, then the visitor may be required to provide information required for each profile level between the current level of the visitor and the level required to access the content. Turning back to FIG. 4, if the visitor 406 at the “Entry” level profile 402 has attempted to access content gated at the “Identify Pain Points” level 408, the visitor 406 would be presented with the opportunity to provide information required to advance to both the “Identification” level 404 and the “Identify Pain Points” level 408. These requests could be presented simultaneously in the same web form, or they could be presented sequentially, so that if the visitor 406 fills out the “Identification” level information, but chooses not to fill out the “Identify Pain Points” level information, the profile level of the visitor 406 may still increase to the “Identification” level 404. If enough information is provided to advance the visitor 406 at least one profile level, but not enough is provided to advance the visitor 406 to the profile level required by the gated content, then the website may block access to the content, provide limited access to the content, or provide full access to the content, depending on the embodiment.

In addition to ascending multiple levels when gated content is accessed, it may also be possible to ascend multiple profile levels when information is imported from a business account or discovered via an IP address. When a user profile is associated with a business account, information from the business account may be associated with the user profile, or the information may be imported and stored in the user profile. If all of the information required for a profile level is imported or available from a business account, then the profile level of the visitor may be increased without requiring the visitor to provide any additional information.

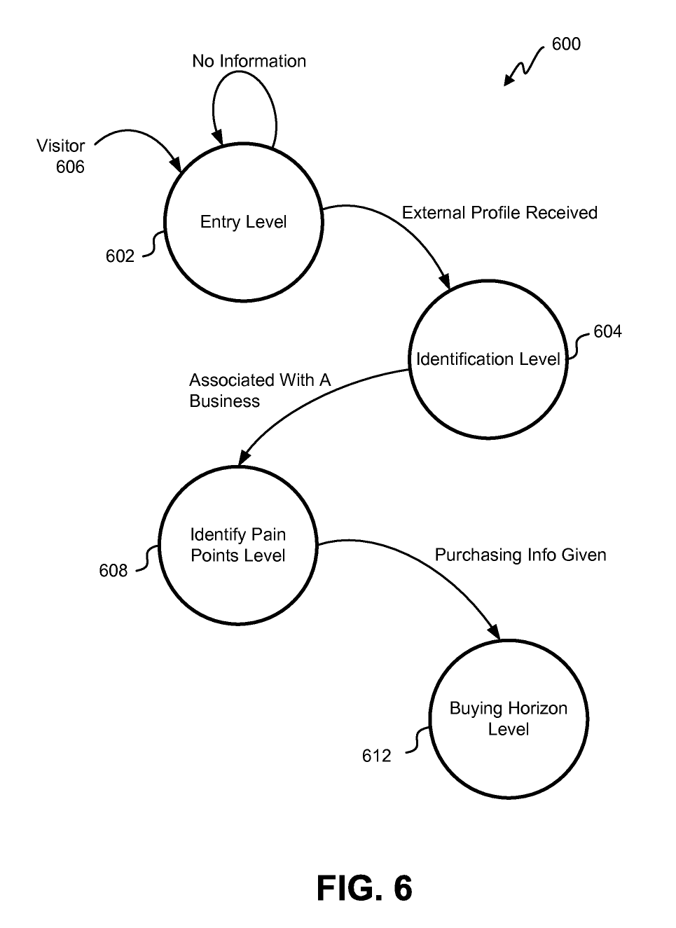

Similarly, a user may be elevated within the hierarchy of profile states when information is provided by an external data source during a login procedure, or when an external data source is linked to an existing profile. FIG. 6 illustrates a state diagram 600 of a progressive profile system that allows for external data source logins. In this embodiment, a visitor 606 may initially be placed in an entry-level state 602, where the visitor 606 will remain until information is received.

Next, the visitor 606 may explicitly log in using an external data source, and information may be provided by the external data source. Similarly, a visitor 606 may decide to link an external data source with an existing account, after which profile information may be retrieved from the external data source. Also, the website may determine that a visitor 606 is already logged into an external data source, and may query the external data source for profile information. In any of these cases, the information provided by the external data source may be sufficient to elevate the progressive profile level for the visitor 606. For example, after receiving external profile information, the visitor 606 may be elevated to the “Identification” level 604.

At any time, the website may make additional queries to the external data source for additional information. For example, an external data source may provide personal profile information during a login procedure. However, the external data source may provide an interface that allows the website to request additional information. For example, the website may request business information such as an employer, a business address, a business field, work associates, business contact information, and/or the like. Receiving such information may be sufficient to elevate the profile state of the visitor 606 to, for example, the “Identify Pain Points” level 608.

Information provided by an external data source may be integrated seamlessly with the system as described above. For instance, sufficient information may be supplied by the external data source to progress through the “Identification” level 604 and the “Identify Pain Points” level 608. Afterwards, the visitor 606 may provide explicit purchasing information to the website and thus be elevated to the “Buying Horizon” level 612. Also, receiving profile information from an external data source may allow the visitor 606 to progress through multiple profile levels at a time, depending on the amount of information received.

Additionally, if only a portion of the information required for a certain level is included in the business account, then only the remaining information may need to be requested from the visitor to ascend to the profile level. Such a request may occur when the profile trigger event occurs, when the visitor accesses gated content at that level. Additionally, the visitor may be given the opportunity to immediately supply the information when the relationship is established with the business account. Similarly, if information about the visitor is received by using the IP address of the visitor, the profile level may be increased in the same way.

In one particular embodiment, information may be received from an external data source during a login procedure that is insufficient to progress beyond the current profile state level. In order to progress a user through to a higher profile level, additional information may be required from the visitor. In one embodiment, a visitor may be provided with a web form displaying all of the information required to progress to the next level. Fields within the web form may be filled in with information received from an external data source. For example, the web form may be displayed with the first name, last name, e-mail address, home address, photograph, and/or employer already filled out if this information was previously received from an external data source. The visitor would then be required to only fill in the information that remained.

In another embodiment, when filling out a web form a visitor may have the option of linking external data source to their current account, and thereby importing profile information stored at the external data source. For example, an input could be provided by the webpage instructing the visitor to, for example, “import information from Facebook.” The visitor could then be instructed to provide login credentials for the external data source. The website could then retrieve information from the external data source and automatically fill in all or part of the web form.

In some embodiments, the various profile levels, with their associated trigger events and information requests, may be established and adjusted within the WCMS. One embodiment may include an interface for selecting information fields for a profile level. The interface may include a subset of information fields that may be included in an information request to the visitor. For example, it is possible to select the “First Name”, “Job Title”, and “E-mail” fields as information required to progress to the “Identification” level of a profile progression. It is understood that many different information fields may be displayed and selected, and that those listed above are merely illustrative. An interface in the WCMS may also be used for selecting the trigger events for each profile level. The interface may allow an administrator to define and name a number of discrete levels. The interface may also allow for the selection of a lead score that may act as a trigger for each level, as well as an order of progression between the profile levels and the number and types of information fields required for each profile level. Other embodiments may use different styles and methods of creating and adjusting progressive profiles.

### Interests

In addition to tracking the lead score, profile level, business account, and provided information, some embodiments of the current invention also determine and/or solicit a set of interests from a visitor. “Interests” as used herein, represent the classification of visitors. For example, interests may map to different types of personas that the website is intended for. Interests could also map to different business solutions offered by the website, or to main verticals served by the operator of the website.

It may be useful to draw a distinction between the interest assignment and utilization that takes place in some embodiments described herein and the “suggested products” or banner advertisements that are often displayed on retail websites. The interests in some embodiments need not be based on physical or other characteristics of products viewed by a customer, nor need they be based on activity on websites outside of the immediate domain of the business website used by these embodiments. The interests of these embodiments can ultimately be used to identify business problems that the visitor is concerned with and to link them to business solutions provided by the organization of the website in the business-to-business market context. Unlike most advertisers that track visitors across various sites without recording identifiable information, the interests of these embodiments can instead rely heavily on identifying information provided by a visitor. The interests can also be refined based in this information gathered from visitors with each successive interaction with the website.

For example, Google's AdSense software attempts to produce advertisements based on tracking a user's web interaction over a numerous sites without recording identifying information. In contract, some embodiments of the lead management system can instead rely on personal information provided voluntarily from a visitor, and some embodiments only use that information within the single website administered by the WCMS. Additionally, embodiments of the lead management system of this invention may attempt to match business solutions offered by the website to the business associated with each visitor, while advertising software targets retail products for individual purchasers. While the website using these embodiments may include advertisements administered by third parties such as Google's AdSense, data need not be shared, the products could be very dissimilar, and the two systems could operate on completely different principles.

The number and types of interests may vary, and may be tailored to the needs of each individual business. Typically, the number of interests will be small compared to the number of categories for content on the website. In one embodiment, the website content is first divided into categories, and then visitor interests are established independently. The number of categories may correspond to individual products, departments, types of media, authors of documents, etc., and these categories may be extensive. In comparison, the website may only have a few interests corresponding to the different major problems that are addressed by the business solutions of the website.

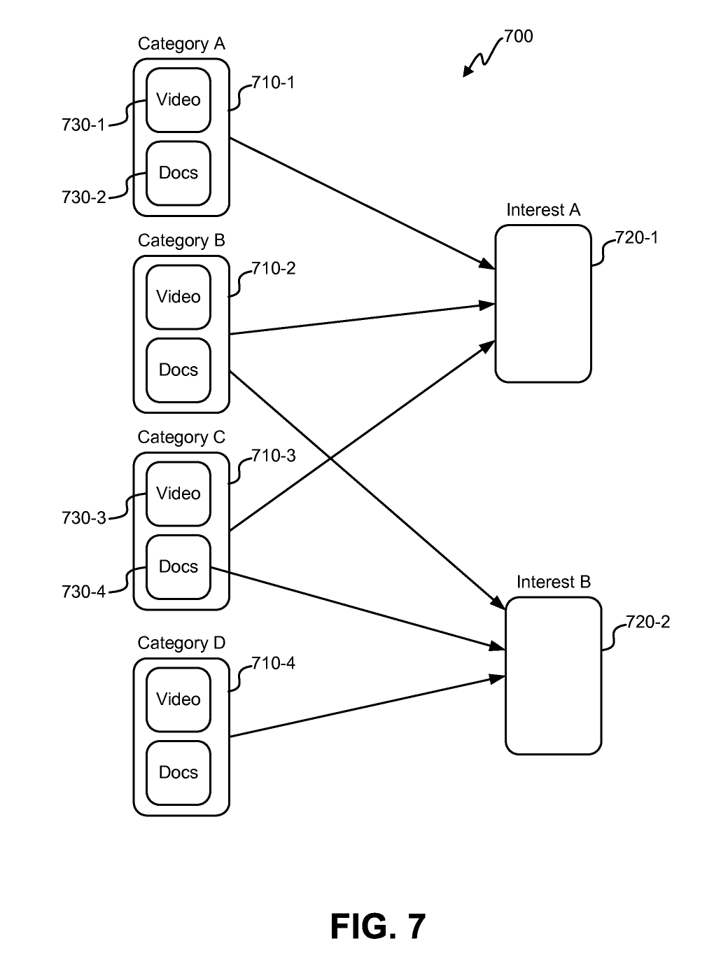

One method for determining the interests of a visitor is to track the interactions of the visitor with the website. Content and navigation actions can be related to one or more interests, and those interests may then be related to the visitor. FIG. 7 illustrates one embodiment for relating interests to categories of content. Each instance of content, such as a document 730-2 or a product video 730-1, can be assigned to at least one content category 710. Each content category 710 may then be associated with one or more interests 720. A content category, such as category B 710-2, may be associated with more than one interest, such as Interest A 720-1 and Interest B 720-2. For example, a series of white papers may be related to an interest named “Marketing Solutions” and related to an interest named “Management Solutions.” Individual instances of content within a category may also be assigned to an interest in addition to, or in the place of, the interest assignments of the content category. For example, document 730-4 may be individually assigned to Interest B 720-2, while the rest of the content in category C 710-3 may be associated with Interest A 720-1. In another example, document 730-4 may be assigned to both Interest A 720-1 and Interest B 720-2, while the rest of the content in category C 710-3 may be only associated with Interest A 720-1.

As a visitor interacts with the website by accessing content, the interests associated with the content may be imputed to the visitor. In one embodiment, after a visitor has accessed a threshold number of content items associated with an interest, that interest may be recorded in the user profile of the visitor as an interest for the visitor. A visitor may be assigned multiple interests. Assigning an interest may depend on quantity, frequency of access, and a comparison to other interests. For example, if a visitor accesses three different documents all pertaining to a single interest, that interest may be assigned to the visitor. On the other hand, if in addition to those three documents, the visitor accessed ten documents in each of two different interests, then the latter two interests may be assigned to the visitor instead of the first interest because the visitor exhibited more interest in the latter two interests by comparison. It will be understood that interests may be dynamically assigned and unassigned to each visitor based on the continued interactions by the visitor and his/her expression of interests.

In addition to determining the interests of a visitor based on the interactions of the visitor with the website, some embodiments also determine interests both implicitly and explicitly from the user profile of the visitor. When a visitor provides certain types of information, such as business type, business role, business size, and/or various “pain points” (business problems in need of a solution), this information may lead to the assignment of one or more interests. For example, if the interests of the website are related to the business role of the visitor, such as manager, IT specialist, or marketing and sales representative, then a visitor who selects a business role that can be mapped to one of these website interests, and the interest may be assigned to the user profile of that visitor. The interests of a visitor may also be explicitly assigned by presenting the visitor with a listing of interests during a request for information when the visitor attempts to ascend to a higher profile level. A visitor who selects categories of interests may be assigned those interests. Alternatively or additionally, assignment of an interest that is explicitly chosen by a visitor may be overridden by the interactions of the visitor with the website, or vice versa. For example, if a visitor selects an interest corresponding to marketing and sales, but the interactions of the visitor exhibit only an interest in management solutions, then the marketing and sales interest may be replaced or supplemented by the management solutions interest.

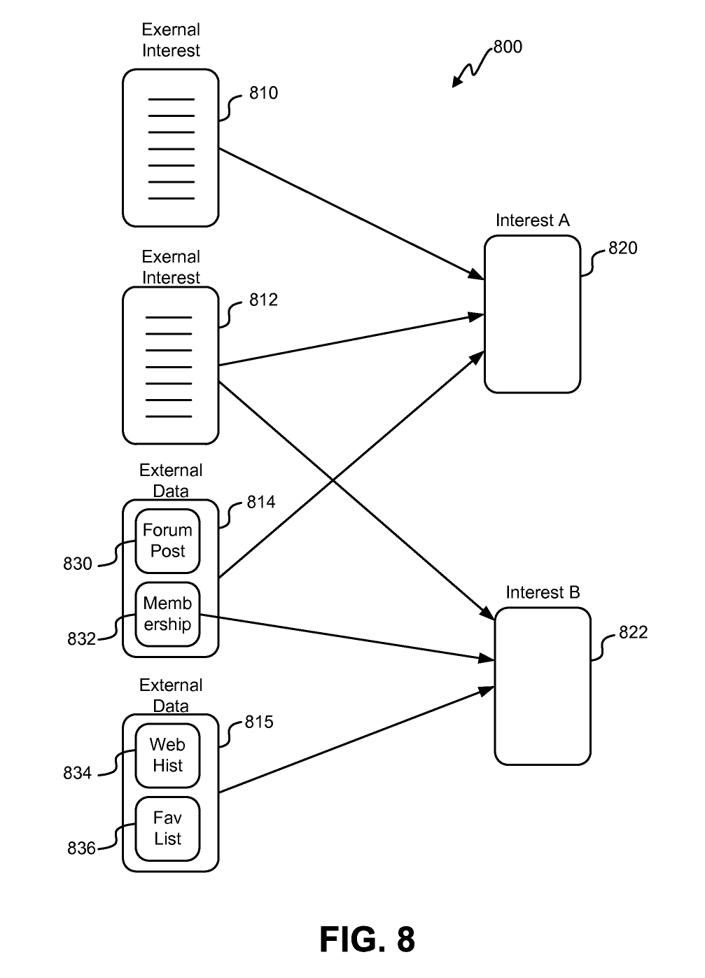

FIG. 8 illustrates a diagram 800 depicting linking interests ascertained from an external data source with website interests, according to one embodiment. Interests may be explicitly requested from an external data source, if the external data source stores such interests. For example, Facebook® may be able to provide topics that have been specifically identified by the visitor as an interest. Other external data sources may similarly store interests that are provided by the visitor.

In one embodiment, importing interests from external data sources may require a special software module to operate. For example, a SAML-compliant module may be implemented that specifically requests types of information from the external data source during a login procedure. After retrieval, the module may be used to decode, categorize, and/or assign the information to various website interests, categories, and/or the like.

In FIG. 8, external interests 810 and 812 may be explicitly provided by the external data source. The software module described above may be used to map external interests 810 and 812 to one or more of the interest defined by the website, such as Interest A 820. In cases where data provided by external data sources is not specifically formatted as an interest, the software module may instead parse through the external data and map it to existing interests. For example, external data 814 may include a forum post 830 and an organization membership 832. The content of the forum post 830 might be mapped to Interest A 820, while the subject matter related to the organization membership 832 could be matched to Interest B 822. Similarly, external data 815 might include, for example, a web history 834 and a favorites list 836. Assuming that the contents of each component of external data 815 are similar, the entirety of external data 815 can be mapped to Interest B 822. Of course, interests mapped by external data sources may be used to tailor the navigation and/or content of the website in the same way that other interests are used as described elsewhere in this disclosure.

A visitor may also be assigned interests based on an association with a business account. A business account may have interests assigned to it in the same way that a visitor is assigned interests. Information provided by the business may reveal, either implicitly or explicitly, that the business is concerned with particular interests. Additionally, a business account may be assigned interests based on the interactions and information provided by visitor associated with the business account. For example, if a large number of visitors associated with a single business account express or demonstrate an affinity for a particular interest, then that interest may be assigned to the business account. Similarly, each individual visitor who is assigned to the business account may be linked to the interests of the business account. Interests that are passed between visitors and a business account may be dynamically updated based on new activity and usage thresholds. For example, if a business account is assigned a marketing and sales interest, but each visitor who is subsequently associated with the business account expresses or displays an interest in management solutions, then the marketing and sales interest may be removed from the business account, as well as from each of the individuals associated with the account. This example is merely illustrative, and it will be understood that many different methods may be used to tailor the assignment and updating of interests between visitors and businesses according to the individual needs of the organization of the website.

Interests may be assigned, updated, and determined according to fields in an interface within the WCMS. The interface may include a listing of interests that have been created within the WCMS. Interests may be added or removed from the list on the interface. Each interest may be assigned to one or more categories of content on the website using a categorize link that allows for the assignment of interests to categories. Of course, many different types of interfaces are possible, and interests may be created and assigned in alternative ways. For example, each content instance could be assigned to an interest by a content designer or web programmer.

### Group Accounts

In the preceding discussion, individual user profiles were discussed in detail. Although previously discussed, the concept of group profiles will be discussed in relation to individual user profiles in this section in greater detail. As described above, individual users can be associated with a user profile. The user profile may have a profile state assigned from a hierarchy of profile states. User interactions with the website may contribute to a lead score, and when the lead score exceeds or meets a threshold value, the user may be prompted for additional information. When the user provides such information, the profile state may be elevated within the state hierarchy. The layout and content of the website may be tailored and made available based on a user's profile state.

Similarly, group profiles may also be maintained and updated based on individual user interactions. In a general sense, a group profile may aggregate the interactions between a plurality of users and the website. The users who are selected for the group may share one or more common characteristics such that it makes sense to tailor website content and structure for the entire group of users. Merely by way of example, a group profile may be established for users who share a common geographic location. Users on the East Coast may prefer to see a certain type of content, while users on the West Coast may prefer a different type of content. Also, users close to a retail location of a business may be presented with a website configured to direct the users to the retail location, whereas users who are geographically remote from a retail location may be presented with a website configured to solicit online transactions.

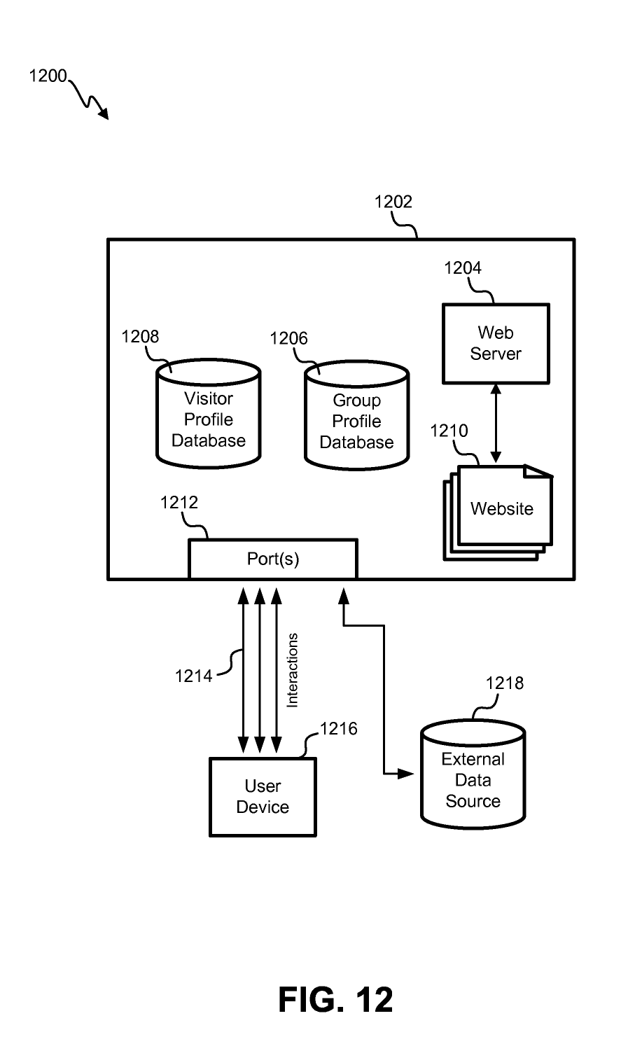

FIG. 12 illustrates a block diagram 1200 of a system for maintaining group profiles, according to one embodiment. The system may include a lead management system 1202 that is configured to track and groom visitors to a website until they become qualified sales leads. The lead management system 1202 may include one or more ports 1212 configured to receive interactions 1214 from one or more user devices 1216. The one or more ports 1212 may also be configured to communicate with an external data source 1218. The lead management system 1202 may further include a Web server 1204 configured to provide information associated with a website 1210 to the user devices 1216. Each of these elements may function in a manner similar to the elements described in configurations depicted elsewhere herein.

In one embodiment, the lead management system 1202 may include both a visitor profile database 1208 and a group profile database 1206. The visitor profile database 1208 may be configured to store user profiles for individual visitors. In contrast, the group profile database 1206 may be configured to store group profiles that are based on the individual interactions of one or more individual users. It will be understood that other components of the lead management system 1202 may not be shown explicitly in FIG. 12 for brevity, including various components shown in FIG. 2A and FIG. 2B.

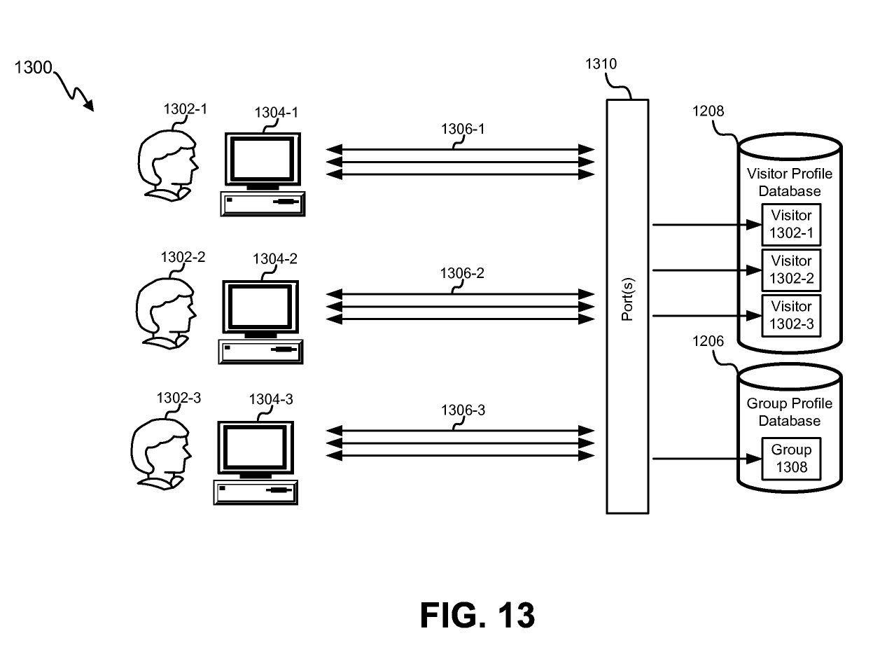

FIG. 13 illustrates a block diagram 1300 depicting interactions between a lead management system and a plurality of users, according to one embodiment. In this embodiment, a plurality of users 1302 may interact with the lead management system using a plurality of individual user devices 1304. The user devices 1304 may include desktop computers, thin clients, workstations, servers, laptop computers, notebook computers, smart phones, PDAs, and/or any other computing device. In one embodiment, a user need not be directly interacting with a user device. For example, a user device may be operated by an automated process to periodically communicate with the lead management system in the absence of an actual user.

Each of the user's 1302 may be associated with a set of interactions 1306 that are part of a communication session. Generally, a communication session may be considered a semi-permanent interactive information exchange, also known as a dialogue, between two or more computing devices, or between a computer and a user. A communication session may be set up or established at a certain point in time and stopped at a later point in time. An established communication session may involve more than one message in each direction. In a specific context, a communication session may be also referred to as a web session. Each of the set of interactions 1306 can be grouped together into one or more communication sessions associated with each individual user 1302 and/or user device 1304.

The lead management system may receive interactions 1306 from the user devices 1304 through one or more ports 1310. Initially, each of the plurality of users 1302 can be associated with an individual visitor profile stored in a visitor profile database 1208. Recall that the terms “user” and “visitor” may be used interchangeably herein. For example, interactions 1306-1 associated with user 1302-1 may be stored in the visitor profile database 1208. The individual visitor profile for visitor 1302-1 may record interactions 1306-1, as well as any future interactions associated with visitor 1302-1. Additionally, a profile state may be stored that is based on information provided by visitor 1302-1. In some embodiments, this provided information may also be stored in the visitor profile along with any other information that may be useful in evaluating visitor 1302-1 as a qualified sales lead. Note that an individual visitor profile may store interactions from both a current communication session as well as previous and/or future communication sessions.

As the interactions 1306 are received by the lead management system, the lead management system may be configured to automatically determine one or more characteristics associated with each communication session as well as prior communication sessions. In some cases, the characteristics may be associated with the interactions. These may include detected user behaviors, navigation patterns through the website, timing of the interactions, types of content accessed, and/or the like. In other cases, the characteristics may be associated with the user devices 1304. These may include hardware configurations, MAC addresses, IP addresses, machine locations, and/or the like. In other cases, the characteristics may be associated with the user's 1300 themselves. These may include names, e-mails, job titles, interests, hobbies, race and ethnicity, national origin, addresses, employers, past employers, friends and acquaintances, and/or the like. The lead management system may be configured to detect these characteristics in real time as the interactions 1306 are received by the lead management system. Note that multiple characteristics may be associated with each communication session. In some cases, characteristics that seemed to be apparent during the beginning stages of a communication session may be superseded or replaced by other characteristics that present themselves more dominantly throughout the remainder of the communication session.

In one embodiment, only the most prominent characteristics that exceed a threshold level of detection are associated with a communication session, while less prominent characteristics continue to be analyzed until they exceed a threshold level of detection. For example, a user may provide an e-mail address at the beginning of a communication session that seems to indicate an employer characteristic based on the e-mail domain. This employer characteristic may be stored initially, but may later be superseded by new characteristics that are detected throughout the communication session, such as hobbies, geographic locations, and/or product interests that are exhibited more strongly. Note that in other embodiments, all detected characteristics may be saved and/or associated.

When a single characteristic is exhibited by and detected for a threshold number of individual visitor profiles, a group profile may be automatically established based on that characteristic. In one embodiment, a separate group profile may be established for each individual characteristic that is detected above a threshold amount. In another embodiment, group profiles may be established for multiple characteristics. For example, a group profile may be established for users in certain geographic locations who are interested in a certain product type having a particular job title. Group profiles may also be combined and separated as they grow dynamically over time. As group shrink, they may also be combined. In one embodiment, it may be detected that certain characteristics are often exhibited by the same visitor profiles. In this case, groups associated with each of the certain characteristics may be combined to form a single group.

In one exemplary embodiment, groups may be based on business needs, employers, and/or professional services. Each employer may be assigned their own group profile. In another embodiment, each class of employers or each market segment may be assigned their own group profile. In yet another embodiment, group profiles may be established according to products offered by the website, thus grouping visitors together who are interested in, and products. In yet another embodiment, groups may be based on geographic locations and/or proximity to products and/or services offered by an organization associated with the website.

In the example shown in FIG. 13, each of the three visitors, namely visitor 1302-1, visitor 1302-2, and visitor 1302-3, may be found to be associated with one or more common characteristics. In this case, information associated with each of the visitor's 1302, the user devices 1304, and/or each of the associated individual visitor profiles may be associated with a group profile 1308 in the group profile database 1206.

Each group profile may be associated with a profile state similar to the hierarchy of profile states established for the individual user profiles. The type of information stored in a group profile may be similar to the type of information stored in an individual user profile. In one embodiment, some or all of the interactions with the website for each individual user may be stored in the group profile. In another embodiment, the group profile may rely on the individual user profiles to store and analyze individual interactions, and the group profile may instead store aggregate information or analysis based on the individual interactions. For example, the group profile may store a total number of employees associated with a characteristic business of the group. A group profile may also store a list of products viewed by any member of the group. The group profile may also store information that is associated with successful lead qualification of individual users.

In one embodiment, a group profile may be configured to store information that is associated with an entity associated with the group's users. As described above, external data sources, such as external logins, identity management systems, and/or social websites, can be used to provide information for individual users. The group profile may store information from these external data sources. In one embodiment, an external data source may include a service that provides information based on a detected IP address. The services may provide a business entity and business information that are associated with the IP address. For example, a number of individual users accessing the website from a common gateway associated with a single business, the IP address for each user's communication session will indicate that they are all associated with the single business. The lead management system may then use the IP address(es) to solicit additional information about the business from an external data source. This information may then be associated with the group profile.

Like individual user profiles, a group profile may also store a lead score associated with the group. The lead score may represent an aggregation of lead scores of the various users associated with the group. In one embodiment, each time a lead score for an individual user is altered, the same alteration may be reflected in the group lead score. In other embodiments, the group lead score may be tracked, calculated, and incremented using metrics different than those used by the individual user profiles. For example, an individual user interaction with the website that adds 10 points to the individual's lead score may add only a fraction of that, such as 2 points, to the group's lead score. Other embodiments may weigh the contribution of each individual users lead score to the group's lead score according to various factors such as total user interactions, user job titles, and/or the like. For example, a user with the job title of “manager” may contribute more to a lead score than users with the job title of “janitor”.

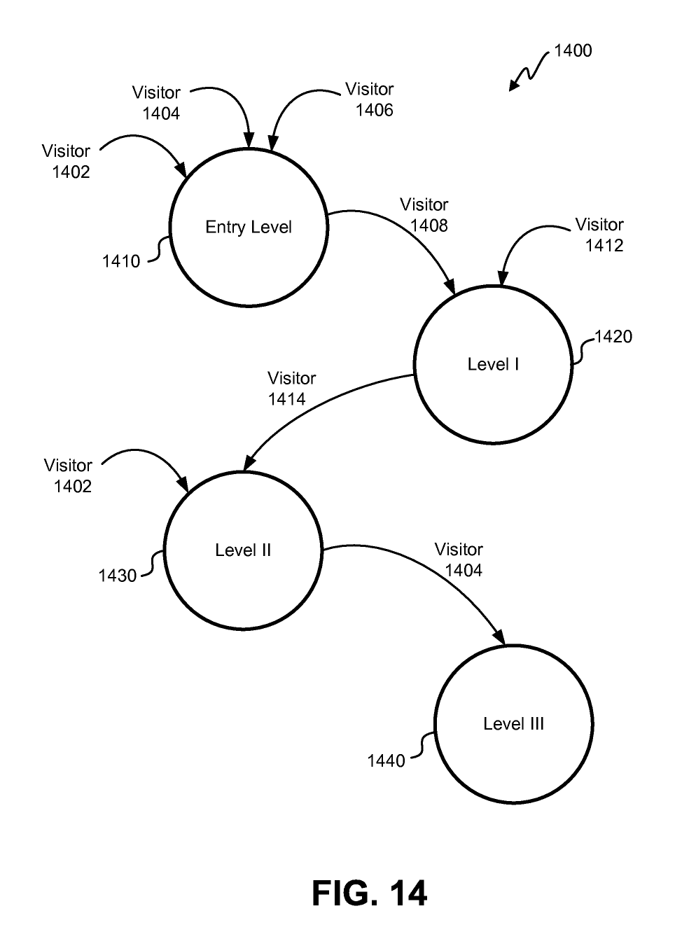

Similarly, the hierarchy of profile states associated with group profiles may operate similar to the hierarchy of profile states associated with individual user profiles. FIG. 14 illustrates a state diagram 1400 for a progression through group profile states, according to one embodiment. In this embodiment, a group profile may begin in an entry level state 1410. Various visitor interactions may contribute to a lead score while the group profile resides in the entry level state 1410. For example, visitor 1402, visitor 1404, and visitor 1406 may provide contributions to the group profile lead score by virtue of their individual interactions with the website.

In one embodiment, advancing to a subsequent profile state may require interactions or information to be provided by a threshold number of visitors. In this embodiment, no matter how much information visitors 1402, 1404, and 1406 provide, the group profile state may not progress until more visitors associated with the group interact with the website or provide information. In other embodiments, the number of visitors need not be taken into account, and sufficient interactions and/or information from even a small number of visitors may be sufficient to elevate the group profile state.

In the example of FIG. 14, information provided by visitor 1408 may be sufficient to elevate the group profile state from the entry-level state 1410 to a subsequent level I state 1420. It may be that the information/interactions provided by visitor 1408 was sufficient to cross a threshold, or that visitor 1408 surpassed a minimum number of visitors required to ascend to the next group profile state.

While residing in the level I state 1420, the lead management system may identify new visitors who share a common characteristic with the group and add their interactions to the group profile state. For example, visitor 1412 may be added to the group after it has progressed into the level I state 1420. As new visitors are added, their information/interactions may also contribute to the lead score of the group profile. In one embodiment, the entire history of interactions and information provided by the new visitor may contribute to the lead score of the group profile and cause it to ascend to a higher group profile state. In another embodiment, only future interactions and information provided by the new visitor may contribute to the lead score of the group profile. In this example, visitor 1414 may be newly associated with the group profile. By virtue of this association, the interactions of visitor 1414 may be used to increase the lead score of the group profile and to cause the group profile to ascend to a level II state 1430. In this case, changing the group profile state may be done simply by virtue of associating visitor 1414 with the group profile. This may be based on either a cumulative history of information and interactions from visitor 1414, or based on the information and interactions provided by visitor 1414 during a current web session.

While residing in the level II state 1430, the group profile may continue to receive information and interactions from each of its associated users. For example, visitor 1402 who previously contributed to the group profile lead score while in entry-level state 1410 may continue to provide information and/or interactions to the website. Similarly, visitor 1404 may also make contributions to the group profiles lead score such that the group profile is elevated to a level III state 1440. Note that in this example, the profile level states our generic. In some embodiments, they may be associated with specific profile levels, states such as “Identify Pain Points”, which were used for individual user profiles. In other embodiments, other state identifiers may be used that are more specific to group profiles, such as “client”, “competitor”, and/or the like.

In lead management systems where interests can be associated with categories of content, interests may also be associated with group profiles. Recall that user profiles can be associated with interests established by the website that relate to, for example, vertical organizations, product categories, business solutions, and/or the like. Similarly, the same types of interests can be associated with group profiles. In one embodiment, interests may exist that are only applicable to group profiles, as well as interests that are only applicable to individual profiles.

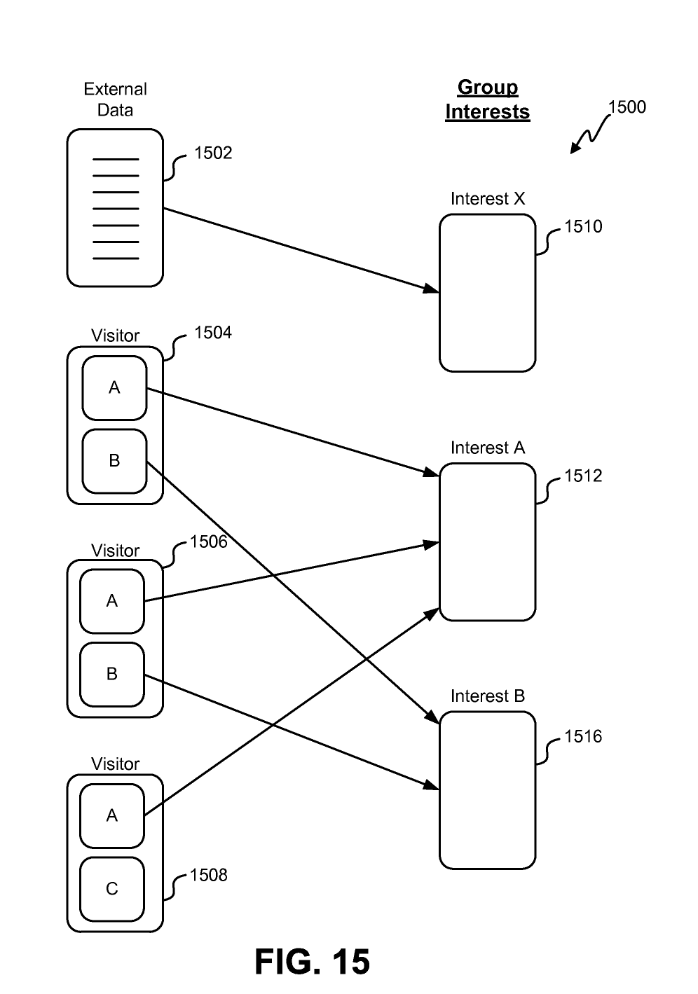

FIG. 15 illustrates a block diagram 1500 of associating interests with group profiles, according to one embodiment. This example illustrates how interests from individual visitors can be imputed to the group interests. In some embodiments, if a particular interest is sufficiently represented among the individual visitors associated with the group, the group may adopt that interest as representative of the group. A threshold number of visitors or a threshold amount of interest expressed by the visitors may be required in order to adopt the interest as a group interest. For example, visitor 1504, visitor 1506, and visitor 1508 are all associated with interest A. Because all three visitors are associated with interest A, this interest can be assigned as a group interest 1512 for the group profile.

Similarly, two of the three visitors are associated with interest B. If a threshold or percentage of visitors is used, two thirds may be sufficient to assign interest B as a group interest 1516. Note that in this example, interest C is only associated with visitor 1508. In some embodiments, if too few visitors have been associated with an interest, or if a larger number of visitors are only weakly associated with an interest, then the interest need not be assigned as a group interest. In this case, interest C need not be assigned as a group interest.

Some interests may be assigned to a group profile even in the absence of that interest being assigned to any of the individual visitor profiles associated with the group. For example, data obtained from an external website, such as business data 1502 may be used to identify an interest that may only be applicable to a group. Interest X may be associated with a business. Interest X may be associated with the group profile even if it is not associated with any individual user profiles.

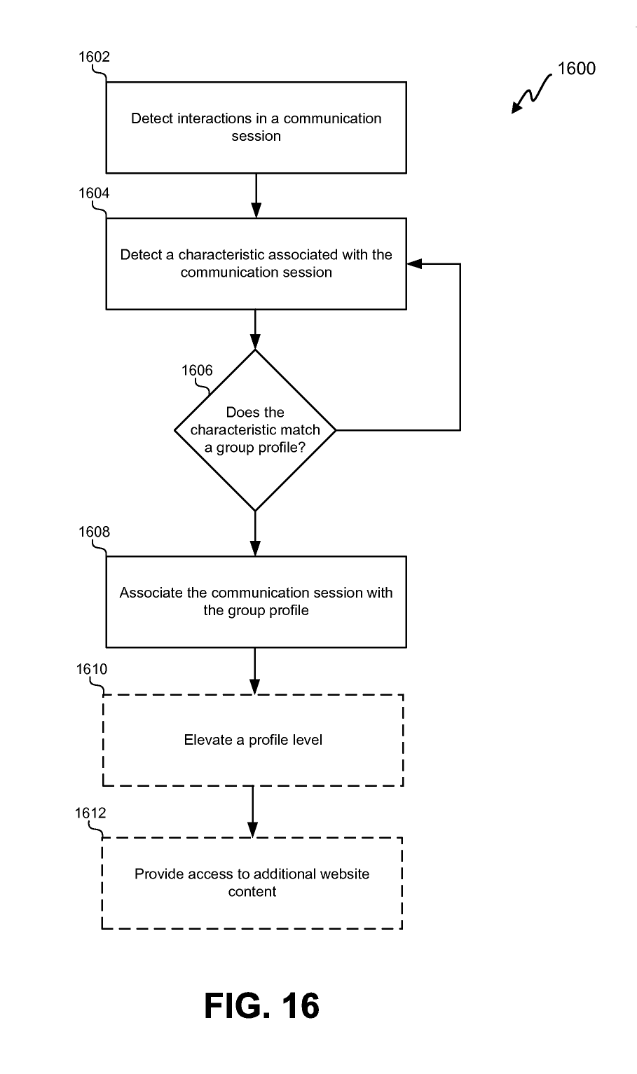

FIG. 16 illustrates a flowchart 1600 of a method for using group profiles, according to one embodiment. The method may include detecting interactions in a communication session (1602). These interactions may be used to provide information from a Web server to a user device for a website. The communication session may be comprised of one or more interactions between the Web server and a visitor device. In one embodiment, the interactions may span multiple communication sessions. In another embodiment, the same visitor device may be used for each communication session associated with a particular visitor. These interactions may be stored in a visitor profile that is associated with the visitor. These interactions may also contribute to a lead score and may be used to change profile states for the visitor profile.

The method may also include detecting a characteristic associated with the communication session (1604). The characteristic may be detected based on one or more of the interactions between the website and the visitor device, on information provided by a visitor, on information provided by an external data source associated with the communication session, and/or the like. In one embodiment, the characteristic may be a geographic location, while in other embodiments the characteristic may include relationships with organizations, demographics, product/service interests, and/or the like. The characteristic may be detected based on more than one of these factors. More than one characteristic may be detected, and thresholds may be used in the detection process.

The method may additionally include determining whether the characteristic matches a group profile (1606). In one embodiment, the characteristic may be compared to characteristics associated with each of a plurality of group profiles, and the visitor may be associated with any group profiles that match. Thus, a single visitor profile may be associated with multiple group profiles. In another embodiment, each characteristic identified for the visitor's communication session may need to match all or a threshold percentage of the characteristics associated with a group profile before the visitor can be added to the group. Other matching algorithms may include thresholds, statistical analysis, and or other criteria.

If it is determined that the identified characteristics of the communication session cannot be matched to any existing group profile, the method may return to step 1604 to continue detecting characteristics. At some point in the future, new groups may be created that include previously detected characteristics, and the visitor may be added to one or more of those group profiles. Alternatively or additionally, additional characteristic may be detected as the communication session continues, and one of the newly detected characteristics may match an existing group. In one embodiment (not shown) when a communication session fails to match any existing group profiles, the lead management system may attempt to group unmatched communication sessions together and form new groups.

If it is determined that one or more of the identified characteristics of the communication session can be matched to an existing group profile, the method may further include associating the communication session with the group profile (1608). In one embodiment, only interactions recorded during the current communication system may contribute to the lead score of the group profile. In another embodiment, past interactions recorded in an individual visitor profile prior to the current communication session may also contribute to the lead score of the group profile. In either case, future interactions in future communication sessions between the visitor and the website may contribute to the lead score of the group profile. Thus the method may also include detecting additional interactions between the Web server and the visitor device, and storing the additional interactions in the group profile. As stated earlier, these interactions may be stored in a memory location associated with either the group profile or the visitor profile.

Optionally, the method may further include elevating a profile level associated with the group profile (1610). If the interactions associated with the current communication session contribute to the group profile lead score sufficiently, the profile level may change. Additionally, when the visitor is added to the group profile, the information provided by the visitor and stored in an existing individual visitor profile may also provide enough information such that the profile level of the group may increase.

Also optionally, the method may also include providing access to additional website content based on the group profile level (1612). This step may offer a significant advantage for users associated with a group profile. For example, a user associated with a business may receive all the benefits of the group profile on the visitor's first visit to the website. Thus, additional content may be provided to the visitor, and the website may be organized and structured in a way that is tailored to emphasize product/services that may be of interest to the visitor based on their group profile affiliation. In contrast, an individual visitor that is not associated with a group profile may be required to provide significant information and interact with the website over time in order to unlock website content or have the website automatically configured to meet their needs.

In one embodiment, a user may have both an individual visitor profile and a group profile active at the same time. In many cases, the group profile may be at a higher profile state relative to the user's individual visitor profile. In this case, a user may request access to gated content on the website that is restricted based on profile states. The website may determine that the user should not have access to the web content based on their individual profile state. However, if the user is associated with a group profile that has a sufficient group profile state, the user may instead be granted access to the gated content based on the group profile level. This evaluation process may be transparent to the user, and the content may simply be provided by virtue of the group profile level without informing the user that their individual profile level would normally require providing more information to the website.

As described above, certain embodiments described herein may use group profiles and individual profiles concurrently. It will be understood that the details described throughout the entirety of this disclosure can be applied to group profiles and individual profiles alike. For example, lead scoring, progressive profile states, interests, content categories, content customization, qualified lead detection, and/or the like, may be applied to group profiles even if not explicitly stated in this section. In light of this disclosure, one having skill in the art could combine or rearrange the various functions, systems, modules, and profiles to achieve other embodiments that have not been described herein for brevity.

### Using Interests, Profiles, and Lead Scores Create Qualified Sales Leads

Although they are stored in separate fields, it should be apparent that a visitor's lead score, profile information, and interests are inter-related in how they are assigned and accumulated in this invention throughout the interaction of a visitor with a website. Additionally, the lead score, profile information, and interests can be used to tailor the experience of a visitor with the website, to guide the visitor to business solutions that are most likely to meet the business needs of the visitor, and to create a qualified lead to be passed on to the sales department of the website's organization.

As interests are assigned to a visitor and profile information is obtained, the website may provide for conditional content to tailor the experience of the visitor. As described earlier, some content may be gated, such that the visitor is required to provide information and raise their profile level before the gated content may be accessed. If the visitor fails to provide the required information, the visitor may instead be presented with alternative content based on the interests of the visitor or partial profile information that may be designed to entice the visitor to provide the required information and view the originally requested gated content. Also, content could be dynamically presented based on the lead score of the visitor. For example, content X could be displayed for visitors with a low lead score, whereas content Y may be displayed for more engaged visitors with a higher lead score. In another example, a simpler, more streamlined interface may be displayed for a new visitor with a low lead score, whereas a more complete and/or detailed interface may be used for a more engaged visitor with a higher lead score.

Featured solutions, articles, and/or marketing videos may also be dynamically displayed based on the interests and/or profile of the visitor. As the interests of a visitor are identified, the website may dynamically display content that is tagged with the interests of the visitor. For example, the visitor may have an interest named “Corporate Branding and Marketing.” On the home page of the website, the business solutions and content related to “Corporate Branding and Marketing” may be prominently displayed, and additional white papers, demonstration videos, and/or more advanced materials may be added to the areas of the website dedicated to that interest. Also, a user profile may include geo-location data based either on the physical address of the visitor or on a detected IP address. For example, the website may present solutions, information, or live seminars or demonstrations that are located in the same geographic region as the visitor.

In additional to tailoring the content, the layout of the website may change according to the interests and lead score of the visitor. In some embodiments, the links on the website may be presented in a different order or prominence to emphasize the areas of the website that correlate strongest with the interests of the visitor. Additional content and hyperlinks may become available that align with the interests of a visitor as they are identified. In other embodiments, the lead score or profile level of a visitor may determine the amount of the website that is available. For example, a new visitor with a low lead score and/or a low profile level may be presented with fewer hyperlinks, whereas a more engaged visitor and/or a visitor with a higher profile level may have more hyperlinks presented in order to open up more of the website for exploration.

The tailoring of the layout of the website and the content presented to the visitor described above utilizes the profile and/or interests of the visitor. However, it is also possible to tailor the layout and content of the website for a visitor who is anonymous when he/she first interacts with the site using the IP mapping techniques also described above. A visitor who is anonymous may not have any information stored in the associated user profile when first accessing the website, but when the IP address of the visitor is detected, profile information may be used to populate the user profile of the visitor. This information may be used to tailor the content and/or layout of the website on the first visit of the visitor to the website, even though the visitor has not yet provided any information to the website. Thus, the visitor may be presented with content and layouts that are of interest to the visitor without the visitor needed to take any action other than to visit the website.

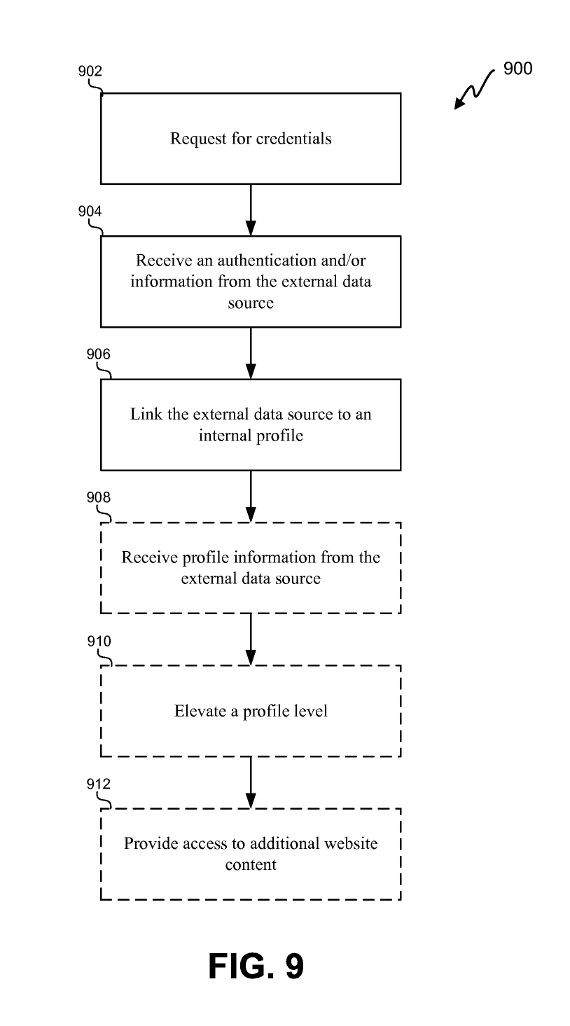

FIG. 9 illustrates a flowchart 900 of a method for linking an internal profile with an external data source, according to one embodiment. The method may include detecting or providing a request for credentials (902). In one embodiment, the request may be provided by the website explicitly. The credentials may then be sent to an external data source by either the website or the user device. The method may additionally include receiving an authorization and/or information from the external data source (904). The information may include a field that can be used as a personal identifier to link the visitor's account on an external data source with an internal profile. In one embodiment, the personal identifier may be an e-mail address, or an external ID number.

The method may further include linking the external data source to an internal profile (906). If no internal profile it exists, one may be created before it is linked to the external data source. In one embodiment, linking the external data source to the internal profile may comprise matching an identifier provided by the external data source with one stored in the internal profile. The method may also include receiving profile information from the external data source (908). In some embodiments, this step may be optional. In other words, it may be sufficient to simply link the external data source to an internal profile, such that the external data source can be used to identify a visitor at each subsequent visit. In other embodiments, however, profile information may be received such as personal information, business information, interests, and/or the like.

The method may also include elevating a profile level (910). As discussed elsewhere herein, the profile level may be elevated according to an amount of information and a type of information received from the external data source. Also optionally, the method may include providing access to additional website content (912). In one embodiment, additional content such as white papers, videos, data sheets, and product pages may be provided to a visitor based on an amount of information provided. In another embodiment, the navigational structure of the website may be changed based on information provided. In yet another embodiment, the type of information, such as an identified interest, may affect the type of content that is provided to the visitor or how it is emphasized in the websites display.

It will be understood that the specific steps listed in FIG. 9 are merely exemplary, and not meant to be limiting. The method described above is but one embodiment of methods that can be used to achieve the operations described herein. The steps in FIG. 9 may be combined into fewer steps. Similarly, each step may be broken down into additional sub-steps. Also, each step may be supplemented with additional information, operations, and structures that are described elsewhere in this disclosure, but not included specifically in FIG. 9 for brevity.

An option may also exist for a visitor to save content and links in a resource portfolio. A resource portfolio may be an area where highly targeted content can be saved and viewed by the visitor, and it is stored in association with the user profile of the visitor. A resource portfolio may include content that has been saved by the visitor for easy reference, e.g., by using a link or button on the website that displays a message similar to “save this item to my resource portfolio.” It may also include content that is related to content that the visitor has saved and/or viewed. It may also include content that is personally targeted to the particular visitor, or to visitors associated with a business account, by a marketer or salesperson associated with the operator of the website. The resource portfolio may also include content that is suggested based on the interests of the visitor. For example an interest in “Corporate Branding and Marketing” may automatically produce content and/or links to content in the resource portfolio that is tagged with the “Corporate Branding and Marketing” interest. The name “resource portfolio” is merely descriptive of this feature's functionality, and it will be understood that any name can be displayed for the visitor based on the desired aesthetics or look and feel of the website.

As described above, the requests for information from the visitor may come in the form of a web form to be filled out by the visitor. The questions may change or be presented in a different order based on the interests or lead score of the visitor. At a point where the interests of the visitor have been sufficiently established, or when the lead score of the visitor reaches a certain threshold, the profile questions may become more directed towards establishing a sales contact with the visitor. For example, advanced questions may be presented on forms entitled something to the effect of “Contact Us”, “Request a Demo”, or “Register for a Webinar”.

In some embodiments, the visitor may be allowed to view, modify, or add to the user profile of a visitor. For instance, if the visitor reaches a certain profile level, reaches a certain threshold lead score, or explicitly requests access to the user profile, the website may allow the visitor to access at least some of the information that has been stored in the user profile. This may allow the visitor to correct any incorrect assumptions regarding the interests of the visitor. Or, it may allow the visitor to select interests in areas that the visitor has not yet explored on the website, such that content and navigational links may be available when the visitor chooses to investigate that interest. Access to the user profile information may be made available to a visitor via a form, link, or tab on the website, such as a “My Profile” page or link. The user profile may be accessed via a user name and password that is individual to each visitor. Alternatively, the user profile may be accessed via user credentials that are shared between at least some of the visitors that are related to a single business account.

In embodiments where the visitor may be allowed to view, modify, or otherwise edit the user profile, the visitor may also be authorized to manage links to accounts maintained by external data sources. For example, a visitor may be allowed to create and/or several links to external data sources that are established or otherwise used during a login procedure. A visitor may also be allowed to authorize certain information to be requested from an external data source, such as business or professional relationships.

Another use for the profile, interest, and/or lead score data is to provide feedback about the performance of the website. One goal of the profile, interest, and lead score system is to help visitors progress from their first interaction through various profile levels until the visitor is determined to be a qualified lead and ready for contact from a sales representative. By tracking visitors and storing information in a user profile, data can be presented that may diagnose where how well the website is progressing visitors to become qualified leads.

One of the main objectives of tracking interests, profiles, and/or lead scores is to generate qualified leads. Relying on lead scoring alone may result in visitors being qualified as a lead by accumulating a lead score that exceeds the lead score threshold, but for which very little information is known. By ascertaining a lead's interests, a qualified lead may be approached with specific products and by specific people with an expertise in the areas that match the interests of the visitor. Additionally, by progressively creating a user profile, the visitor may be immediately contacted once qualified as a lead. This makes the transition from being a visitor on a website to a qualified lead much more seamless, such that the visitor may not even be aware that such a transition has been made. Without progressive profiling, the visitor would be forced to provide all the information at once during the transition to become a qualified lead. Such a scenario may be overwhelming to the visitor and cause the visitor to exit the website before enough of information and/or interests could be ascertained for a successful sales pitch.

The ways in which the lead scores, progressive profiles, and/or interests have been combined above are merely examples of ways in which these data may be used to effectively generate qualified leads. It will be understood that many other combinations of data may be collected and put to uses other than those described herein. Each website may have its own designs and sales objectives for which these embodiments may be tailored in order to meet various business needs. Also, customization of a website is described using a WCMS, but the same customizations could be performed by application software, a run-time applet, a smart phone application, or any software functions that provide information to potential customers and website owners. Therefore, these embodiments are not limiting, and should be considered only to be a few of many possible embodiments.

### Hardware and Software

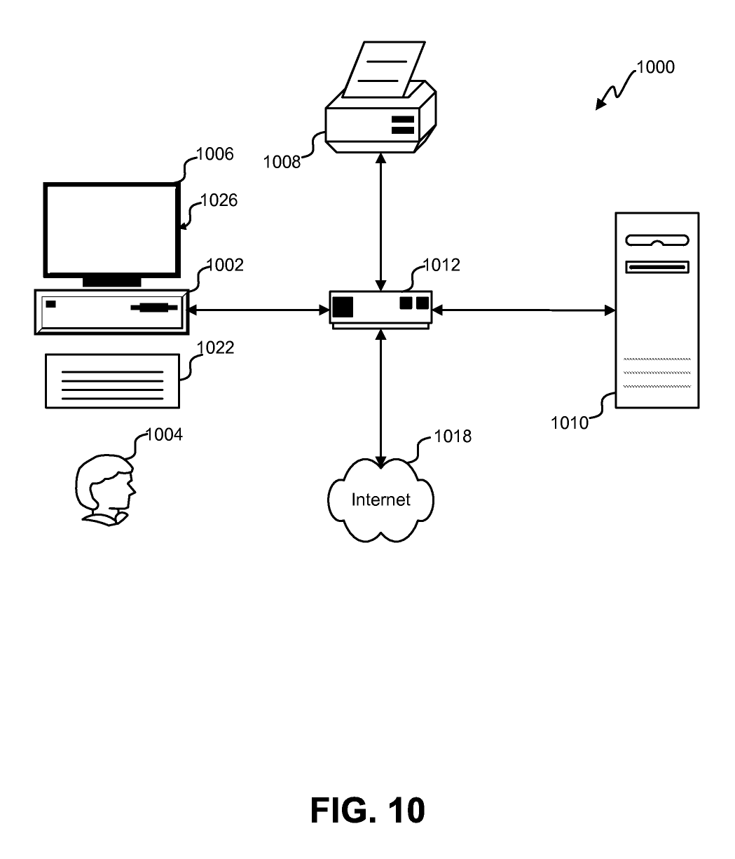

Referring next to FIG. 10, an exemplary environment with which embodiments may be implemented is shown with a computer system 1000 that can be used by a designer 1004 to design, for example, electronic designs. The computer system 1000 can include a computer 1002, keyboard 1022, a network router 1012, a printer 1008, and a monitor 1006. The monitor 1006, processor 1002 and keyboard 1022 are part of a computer system 1026, which can be a laptop computer, desktop computer, handheld computer, mainframe computer, etc. The monitor 1006 can be a CRT, flat screen, etc.

A designer 1004 can input commands into the computer 1002 using various input devices, such as a mouse, keyboard 1022, track ball, touch screen, etc. If the computer system 1000 comprises a mainframe, a designer 1004 can access the computer 1002 using, for example, a terminal or terminal interface. Additionally, the computer system 1026 may be connected to a printer 1008 and a server 1010 using a network router 1012, which may connect to the Internet 1018 or a WAN.

The server 1010 may, for example, be used to store additional software programs and data. In one embodiment, software implementing the systems and methods described herein can be stored on a storage medium in the server 1010. Thus, the software can be run from the storage medium in the server 1010. In another embodiment, software implementing the systems and methods described herein can be stored on a storage medium in the computer 1002. Thus, the software can be run from the storage medium in the computer system 1026. Therefore, in this embodiment, the software can be used whether or not computer 1002 is connected to network router 1012. Printer 1008 may be connected directly to computer 1002, in which case, the computer system 1026 can print whether or not it is connected to network router 1012.

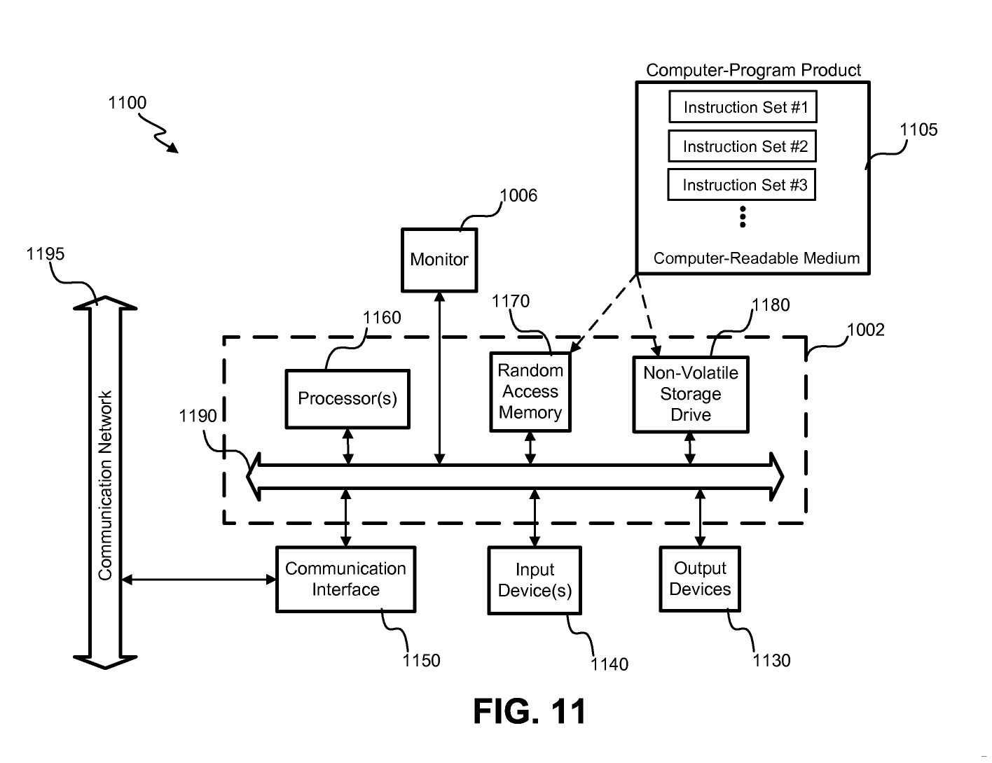

With reference to FIG. 11, an embodiment of a special-purpose computer system 1100 is shown. The lead management system 108 and marketing automation system 112 shown in FIG. 1 are examples of a special-purpose computer system 1100. The above methods may be implemented by computer-program products that direct a computer system to perform the actions of the above-described methods and components. Each such computer-program product may comprise sets of instructions (codes) embodied on a computer-readable medium that directs the processor of a computer system to perform corresponding actions. The instructions may be configured to run in sequential order, or in parallel (such as under different processing threads), or in a combination thereof. After loading the computer-program products on a general purpose computer system 1026, it is transformed into the special-purpose computer system 1100.

Special-purpose computer system 1100 comprises a computer 1002, a monitor 1006 coupled to computer 1002, one or more additional user output devices 1130 (optional) coupled to computer 1002, one or more user input devices 1140 (e.g., keyboard, mouse, track ball, touch screen) coupled to computer 1002, an optional communications interface 1150 coupled to computer 1002, a computer-program product 1105 stored in a tangible computer-readable memory in computer 1002. Computer-program product 1105 directs system 1100 to perform the above-described methods. Computer 1002 may include one or more processors 1160 that communicate with a number of peripheral devices via a bus subsystem 1190. These peripheral devices may include user output device(s) 1130, user input device(s) 1140, communications interface 1150, and a storage subsystem, such as random access memory (RAM) 1170 and non-volatile storage drive 1180 (e.g., disk drive, optical drive, solid state drive), which are forms of tangible computer-readable memory.

Computer-program product 1105 may be stored in non-volatile storage drive 1180 or another computer-readable medium accessible to computer 1002 and loaded into memory 1170. Each processor 1160 may comprise a microprocessor, such as a microprocessor from Intel® or Advanced Micro Devices, Inc.®, or the like. To support computer-program product 1105, the computer 1002 runs an operating system that handles the communications of product 1105 with the above-noted components, as well as the communications between the above-noted components in support of the computer-program product 1105. Exemplary operating systems include Windows® or the like from Microsoft Corporation, Solaris® from Sun Microsystems, LINUX, UNIX, and the like.

User input devices 1140 include all possible types of devices and mechanisms to input information to computer system 1002. These may include a keyboard, a keypad, a mouse, a scanner, a digital drawing pad, a touch screen incorporated into the display, audio input devices such as voice recognition systems, microphones, and other types of input devices. In various embodiments, user input devices 1140 are typically embodied as a computer mouse, a trackball, a track pad, a joystick, wireless remote, a drawing tablet, a voice command system. User input devices 1140 typically allow a user to select objects, icons, text and the like that appear on the monitor 1006 via a command such as a click of a button or the like. User output devices 1130 include all possible types of devices and mechanisms to output information from computer 1002. These may include a display (e.g., monitor 1006), printers, non-visual displays such as audio output devices, etc.

Communications interface 1150 provides an interface to other communication networks and devices and may serve as an interface to receive data from and transmit data to other systems, WANs and/or the Internet 1018. Embodiments of communications interface 1150 typically include an Ethernet card, a modem (telephone, satellite, cable, ISDN), a (asynchronous) digital subscriber line (DSL) unit, a FireWire® interface, a USB® interface, a wireless network adapter, and the like. For example, communications interface 1150 may be coupled to a computer network, to a FireWire® bus, or the like. In other embodiments, communications interface 1150 may be physically integrated on the motherboard of computer 1002, and/or may be a software program, or the like.

RAM 1170 and non-volatile storage drive 1180 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 1170 and non-volatile storage drive 1180 may be configured to store the basic programming and data constructs that provide the functionality of various embodiments of the present invention, as described above.

Software instruction sets that provide the functionality of the present invention may be stored in RAM 1170 and non-volatile storage drive 1180. These instruction sets or code may be executed by the processor(s) 1160. RAM 1170 and non-volatile storage drive 1180 may also provide a repository to store data and data structures used in accordance with the present invention. RAM 1170 and non-volatile storage drive 1180 may include a number of memories including a main random access memory (RAM) to store of instructions and data during program execution and a read-only memory (ROM) in which fixed instructions are stored. RAM 1170 and non-volatile storage drive 1180 may include a file storage subsystem providing persistent (non-volatile) storage of program and/or data files. RAM 1170 and non-volatile storage drive 1180 may also include removable storage systems, such as removable flash memory.

Bus subsystem 1190 provides a mechanism to allow the various components and subsystems of computer 1002 communicate with each other as intended. Although bus subsystem 1190 is shown schematically as a single bus, alternative embodiments of the bus subsystem may utilize multiple busses or communication paths within the computer 1002.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels, and/or various other storage mediums capable of storing that include or carry instruction(s) and/or data.

While the principles of the disclosure have been described above in connection with specific apparatuses and methods, it is to be clearly understood that this description is made only by way of example and not as limitation on the scope of the disclosure.

1. A method of analyzing an Internet-based communication session to use a group profile database and alter group profile states using an aggregated function of individual electronic transmissions, the method comprising:
detecting, using a processor, one or more interactions between a web server and a first visitor device, wherein:
the web server provides information associated with a website to the first visitor device; and
the one or more interactions are part of a communication session;
detecting, using the processor, a characteristic associated with the communication session, wherein:
the characteristic is also associated with each of a plurality of communication sessions; and
at least one of the plurality of communication sessions is associated with a second visitor device;
accessing, using the processor a group profile in a profile database, wherein:
the group profile is associated with the plurality of communication sessions;
the group profile is associated with a group profile state in a hierarchy of group profile states; and
each of the hierarchy of group profile states is based on detected interactions associated with the plurality of communication sessions;
associating, using the processor, the communication session with the group profile;
storing, using the processor, the one or more interactions between the web server and the first visitor device in one or more memory locations associated with the group profile; and
determining, using the processor, whether the group profile state should be changed after associating the communication session with the group profile.

2. The method of analyzing an Internet-based communication session to use a group profile database and alter group profile states using an aggregated function of individual electronic transmissions of claim 1 wherein detecting a characteristic associated with the communication session comprises receiving an Internet Protocol (IP) address.

3. The method of analyzing an Internet-based communication session to use a group profile database and alter group profile states using an aggregated function of individual electronic transmissions of claim 2 wherein detecting a characteristic associated with the communication session further comprises:
sending the IP address to an external data source;
receiving an indication of the characteristic from the external data source.

4. The method of analyzing an Internet-based communication to use a group profile database and alter group profile states using an aggregated function of individual electronic transmissions of claim 1 wherein detecting a characteristic associated with the communication session is based on the one or more interactions between the web server and the first visitor device.

5. The method of analyzing an Internet-based communication session to use a group profile database and alter group profile states using an aggregated function of individual electronic transmissions of claim 1 wherein the characteristic comprises a geographic location.

6. The method of analyzing an Internet-based communication session to use a group profile database and alter group profile states using an aggregated function of individual electronic transmissions of claim 1 wherein the characteristic comprises a relationship with an organization.

7. The method of analyzing an Internet-based communication session to use a group profile database and alter group profile states using an aggregated function of individual electronic transmissions of claim 1 wherein the characteristic comprises a demographic characteristic.

8. The method of analyzing an Internet-based communication session to use a group profile database and alter group profile states using an aggregated function of individual electronic transmissions of claim 1 wherein the profile state comprises a first profile state, the method further comprising:
detecting additional interactions between the Web server and the first visitor device;
storing information associated with the additional interactions in the one or more memory locations associated with the group profile; and
determining that the first profile state should be elevated to a second profile state based on the information associated with the additional interactions.

9. The method of analyzing an Internet-based communication session to use a group profile database and alter group profile states using an aggregated function of individual electronic transmissions of claim 1 further comprising:
storing information associated with the communication session in a visitor profile in a visitor profile database;
assigning a visitor profile state in a hierarchy of visitor profile states to the visitor profile, wherein each of the hierarchy of visitor profile states is based on an amount of information provided by a visitor associated with the visitor profile.

10. The method of analyzing an Internet-based communication session to use a group profile database and alter group profile states using an aggregated function of individual electronic transmissions of claim 9 wherein the profile database and the visitor profile database are the same database.

11. The method of analyzing an Internet-based communication session to use a group profile database and alter group profile states using an aggregated function of individual electronic transmissions of claim 9 further comprising:
receiving a request for website content during the communication session;
determining that the website content should not be provided based on the visitor profile state;
determining that the website content should be provided based on the group profile state;
providing the website content to the first visitor device.

12. A system for analyzing an Internet-based communication session to use a group profile database and alter group profile states using an aggregated function of individual electronic transmissions, the system comprising:
a web server that stores information associated with a website and provides the information associated with the website to visitor devices;
one or more ports that receive transmissions between the web server and a plurality of visitor devices, wherein:
the transmissions comprise one or more interactions between the web server and a first visitor device; and
the one or more interactions are part of a communication session;
a profile database that stores a plurality of group profiles, wherein:
the plurality of group profiles includes a group profile;
the group profile is associated with a plurality of communication sessions, wherein at least one of the plurality of communication sessions is associated with a second visitor device;
the group profile is associated with a group profile state in a hierarchy of group profile states; and
each of the hierarchy of group profile states is based on detected interactions associated with the plurality of communication sessions;
one or more processors configured to:
detect a characteristic associated with the communication session, wherein the characteristic is also associated with each of the plurality of communication sessions;
associate the communication session with the group profile;
store information associated with the one or more interactions between the web server and the first visitor device in one or more memory locations associated with the group profile; and
determine whether the group profile state should be changed after associating the communication session with the group profile.

13. The system for analyzing an Internet-based communication session to use a group profile database and alter group profile states using an aggregated function of individual electronic transmissions of claim 12 wherein the one or more processors are a part of the webserver.

14. The system for analyzing an Internet-based communication session to use a group profile database and alter group profile states using an aggregated function of individual electronic transmissions of claim 12 wherein the one or more processors detect the characteristic associated with the communication session at least in part by receiving an IP address.

15. The system for analyzing an Internet-based communication session to use a group profile database and alter group profile states using an aggregated function of individual electronic transmissions of claim 12 wherein the one or more processors detect the characteristic associated with the communication session at least in part by:
sending the IP address to an external data source;
receiving an indication of the characteristic from the external data source.

16. The system for analyzing an Internet-based communication session to use a group profile database and alter group profile states using an aggregated function of individual electronic transmissions of claim 12 wherein the characteristic comprises a relationship with an organization.

17. The system for analyzing an Internet-based communication session to use a group profile database and alter group profile states using an aggregated function of individual electronic transmissions of claim 12 wherein the profile database further:
stores information associated with the communication session in a visitor profile;
assigns a visitor profile state in a hierarchy of visitor profile states to the visitor profile, wherein each of the hierarchy of visitor profile states is based on an amount of information provided by a visitor associated with the visitor device.

18. A method of analyzing an Internet-based communication session to use a group profile database and alter group profile states using an aggregated function of individual electronic transmissions, the method comprising:
receiving, at a web server, interactions between a visitor device and the web server as a part of a communication session;
detecting, using that the communication session is associated with a characteristic;
determining, using the processor, a group profile in a profile database, wherein:
the group profile is associated with a plurality of communication sessions; and
each of the plurality of communication sessions is associated with the characteristic;
associating, using the processor, the communication session with the group profile;
receiving information from the visitor device;
determining, using the processor, that a group profile state associated with the group profile should be changed to a higher group profile state after receiving the information from the visitor device, wherein the group profile state and the higher group profile state are part of a discrete hierarchy of profile states;
receiving a request for content from the visitor device, wherein the content is gated; and
providing the content based on the higher group profile state.

19. The method of analyzing an Internet-based communication session to use a group profile database and alter group profile states using an aggregated function of individual electronic transmissions of claim 18 wherein the characteristic comprises an association with a business organization.

20. The method of analyzing an Internet-based communication session to use a group profile database and alter group profile states using an aggregated function of individual electronic transmissions of claim 18 wherein each of the plurality of communication sessions is associated with a distinct visitor profile comprising a visitor profile state in a hierarchy of profile states.
